(19) United States
(12) Patent Application Publication
(10) Pub. No.: US 2005/0177420 A1
(43) Pub. Date: Aug. 11, 2005

(54) Shopping system, video rental system, and interactive system using moving picture distribution technique

(76) Inventor: Junichi Tanahashi, Shibuya-ku (JP)

Correspondence Address: SUGHRUE MION, PLLC, 401 Castro Street, Ste 220, Mountain View, CA, 94041-2007, US

(21) Appl. No.: 10/514,879

(22) PCT Filed: May 19, 2003
(86) PCT No.: PCT/JP03/06187

(30) Foreign Application Priority Data
May 20, 2002 (JP) 2002-144344
Oct. 28, 2002 (JP) 2002-312742

(51) Int. Cl. G06F 17/60

(52) U.S. Cl. 705/14

(57) ABSTRACT

A shopping system includes a center server (12), a dedicated terminal (14) always connected to the center server (12) via the Internet (18), and user ID cards (50). When information on selection of a specific commodity is transmitted from the dedicated terminal (14), the center server (12) transmits an advertisement moving picture file of the commodity to the dedicated terminal (14). Moreover, when a purchase request of the commodity is transmitted from the dedicated terminal (14), order information on the commodity is transmitted to a server (16) of the commodity provider. The dedicated terminal (14) is connected to a television (29) and includes a card reader (26) for reading ID cards, a dedicated Web browser, and means for reproducing a moving picture file having audio via the television (29). It also has a remote controller (52) for selecting buttons on the television screen.

### TECHNICAL FIELD

The present invention relates to a moving picture distribution technique, and more particularly, the present invention relates to a moving picture distribution system for realizing an online shopping, an online video rental service, and a remote interactive (video chat) service by using a technology of transmitting and receiving a moving picture file between a dedicated terminal that is connected to a TV set on every home and a server that is installed on the Internet.

### BACKGROUND ART

At the present day, due to explosive growth of the Internet, many people connect to the Internet to acquire and transmit various information.

In other words, preparing an information terminal such as a personal computer (hereinafter, “PC”) and connecting to a server of an ISP (Internet service provider) through a communication line such as a phone line, each one enjoys a service such as a WWW (World Wide Web) and an electronic mail.

In addition, in recent days, an online shopping to purchase various commodities through the Internet has been also generalized.

Further, in accordance with growth of so-called broad band network using a communication network of a broad band such as an ADSL and an optical fiber, it is expected that net distribution of a moving picture content with voice such as a movie and a promotion video will also be generalized in future.

Due to growth of such EC (electronic commerce) via the Internet, a middleman who has mediated between a producer and a consumer so far becomes unnecessary and reduction of cost can be expected by just that much.

As described above, due to advent of the Internet, it cannot be denied that various possibilities and conveniences are offered to an individual's life and a business activity.

However, the EC remains only in an additional transaction type because the EC using the present Internet involves some problems and what's happening is that the EC is far inferior to a real transaction value.

At first, a communication environment of the Internet configured based on the PC involves a problem that it is hard for elder person, children, and house wives to use the EC even at the present day, and they cannot use the EC casually like watching TV.

Secondly, the Internet is as sort of a lawless area of the information, and in the Internet, a highly illegal commodity such as a pornographic image and a drug is traded and a fraudulent business is unregulated, so that this involves a problem that the Internet cannot be used at home with children without anxiety.

Thirdly, although the Internet is a gold mine of information, various information overflow disorderly, so that this involves a problem that a general user cannot efficiently acquire only information and a service beneficial for himself or herself.

On the other hand, a TV shopping to air the advertisements of a commodity and a service by using a normal TV broadcasting and to accept an order from a general viewer through a telephone has been grown and dedicated channels are provided, too.

In the case of this TV shopping, the TV that a user is accustomed to use for a long time is a medium, so that the TV shopping has an advantage that every one at home can easily purchase the commodity beyond generations and the user can get a sense of reassurance with respect to the commodity and the trading because a TV station intervenes between the producer and the consumer. In addition, a description of items is done on the basis of the moving picture and the voice, so that this also has an advantage that a characteristic of the commodity can be sufficiently appreciated.

However, the TV broadcast covers unspecified majority, so that it is necessary for each viewer to continuously view the program till it introduces a commodity that attracts interest of each viewer and it is regrettable that the viewer cannot immediately check the information relating to the desirable commodity when he or she wants to purchase it.

For the item provider, there is no way to effectively specify the target, so that this involves a problem that the item provider should pay an expensive fee for the right to air to secure broadcast time and to air the uniform advertisement to a common people.

In addition, as described above, in accordance with growth of the broadband network, increase of the service for distributing the moving picture contents to each user via the Internet is expected.

However, in the present circumstances, from necessity to evade infringement of an author's right, to download a paid content to an information terminal of the user is not generally approved, and therefore, the user should repeat downloading each time one views the same content and this is very troublesome.

As a matter of course, to store the moving picture file in the information terminal of the user at the same time as reproduction of streaming of the moving picture contents is possible technically, however, if this is approved, concerns about illegal copy are raised, so that it becomes difficult to find a provider of an interesting content.

Further, as a more substantial problem, there has been no system so far in which the general user casually distributes the moving picture content to a third person via the Internet.

It is true that the user describes the moving picture file that the user photographed individually in one's own Web page and other user views it by downloading it in the PC as so far. Alternatively, it is tried to hold a TV conference via a display by connecting a CCD camera to the PC of the both users.

However, in order to realize this, a knowledge and a good deal of time and effort with regard to the Internet and the image processing should be invested, so that it is difficult for all but a few of maniacs and providers to use the online shopping.

The present invention is made in order to solve the above-described problems of a conventional Internet communication environment and an object of which is to realize a system, whereby any one at home can view a moving picture advertisement of a commodity and a service attracting his or her interest and a moving picture content of his or her interested field without anxiety at any time with a television-level convenience via the Internet, the moving content can be saved temporarily according to need, and a moving picture file photographed at the user side can be simply transmitted via the Internet.

### BRIEF SUMMARY OF THE INVENTION

In order to attain the above-described object, a shopping system using a moving picture distribution technique according to claim 1 of the present invention may comprise a center server, a dedicated terminal connected to the center server via the Internet, and an ID card belonging to each user; the center server may comprise a user database for storing the attribution information of each user therein as being related to a user ID and a dedicated terminal ID; a commodity and service database for storing the information with related to a commodity and a service that can be provided to a user; a storage apparatus for accumulating a moving picture file for advertisements of the commodity and the service; a moving picture database for storing the information with related to each moving picture file for advertisements therein; means of carrying out authentication processing with reference to the user database when the dedicated terminal transmits the user ID and the dedicated terminal ID; means of generating a Web page for selecting a commodity and a service with reference to the commodity and service database and transmitting it to the dedicated terminal; means of extracting the moving picture file for advertisements with related to the commodity and the service with reference to the moving picture database when the dedicated terminal transmits the information for selecting specific commodity and service, and of transmitting this moving picture file for advertisements to the dedicated terminal; and means of transmitting the order information of the commodity and the service to a communication terminal of a commodity and service provider when a purchase request of a commodity and a service according to a moving picture file for advertisements is transmitted from the dedicated terminal; and the dedicated terminal may comprise input and output terminals for connecting the dedicated terminal to a television set; a card reader for reading the user ID and the dedicated terminal ID stored in the ID card; means of transmitting the user ID and the dedicated terminal ID to the center server and of requiring authentication of the user; means of displaying the Web page for selecting the commodity and the service transmitted from the center server on a TV screen; inputting means for selecting the commodity and the service displayed on the TV screen; means of transmitting the commodity and service information selected by the user to the center server and requiring the distribution of the moving picture file for advertisements; means of displaying an image of the moving picture file for advertisements transmitted from the center server on the television screen and outputting a voice through a speaker; and means of transmitting a purchase request of the commodity and the service to the center server when the user selects purchase of the commodity and the service through the input means.

According to this system, the user can casually view the moving picture advertisements through a TV screen because authentication of the user is completed only by inserting an ID card into a dedicated terminal that is connected to the Internet. By using a remote controller as the above-described “input means”, even a user who is not used to a PC can enjoy online shopping via the Internet without an uncomfortable feeling.

In addition, the moving picture file for advertisement is distributed upon receiving of a selection request of the user, so that the user can view the moving picture advertisements of a commodity and a service that attracting his or her interest at any time.

Further, a center server transmits the Web page for selecting the commodity and the service and the user may select specific commodity and service from this Web page and there is no need for the user to access to many Web sites. Therefore, even if the user lacks of the knowledge about the Internet, he or she can enjoy the online shopping definitely and there is no risk that he or she is deceived by a dishonest trader.

According to the shopping system using a moving picture distribution technique according to claim 2 of the present invention based on the system of the above-described claim 1, the dedicated terminal incorporates a hard disk therein and comprises means of storing the moving picture file for advertisements in the hard disk at the same time as reproduction of the moving picture file for advertisements.

Thus, by approving download of the moving picture file, the user can view the moving picture advertisements of specific commodity and service any number of times till the user is satisfied, so that a convenience is improved.

In the meantime, it is possible to configure the system so as to include means that a center server divides the above-described moving picture file for the advertisements into a plurality of blocks (for example, one block=500 kbytes) and distributes the file to the dedicated terminal by block units and means that the dedicated terminal stores the moving picture file in a hard disk by the block units. Thus, by distributing the moving picture file by the block units, it is possible for the user to enjoy a so-called trick play (fast-forwarding, rewind, play back at low speed, and pause or the like) with respect to the transmitted blocks before download of the moving picture file has been entirely completed.

According to the shopping system using a moving picture distribution technique according to claim 3 of the present invention based on the system of the above-described claim 2, further, the moving picture file for advertisements is related to the expiration date information in advance; the dedicated terminal may comprise means of deleting the moving picture file when the expiration date of the moving picture file stored in the hard disk comes; and the center server may comprise means of checking if the moving picture file is deleted or not with reference to the interior of the hard disk of the dedicated terminal after the expiration date of the moving picture file; and means of transmitting an instruction to delete the moving picture file to the dedicated terminal in the case the moving picture file remains.

As a result, even if download of the moving picture file is approved, it is possible to protect a copyright effectively.

According to the shopping system using a moving picture distribution technique according to claim 4 of the present invention based on the system of the above-described claim 2 or 3, further, the dedicated terminal comprises means of embedding at least one of the user ID or the dedicated terminal ID in each frame composing a moving picture as the watermark information when reproducing the moving picture file that is transmitted from the server.

As a result, even if the moving picture is illegally copied, it is possible to easily specify its runoff source.

According to the above-described center server according to claim 5 of the present invention based on the system in any one of the above-described claims 1 to 4, further, the center server comprises means of coding the moving picture file for advertisements and means of transmitting this coded moving picture file for advertisements to the dedicated terminal.

Thus, by applying encryption processing that can be decrypted only by the intended dedicated terminal to the moving picture file for advertisements to be transmitted from the center server, even if the file is intercepted by the third person in the middle of transmission, there is no risk that the copy right is infringed.

According to the shopping system using a moving picture distribution technique according to claim 6 of the present invention based on the system in any one of the above-described claims 1 to 5, further, the center server comprises a database for setting an allowable limit of trading of the user and means of rejecting the trading when the purchase request of the commodity and the service over the allowable limit of trading of the user is transmitted from the dedicated terminal.

For example, if a parent sets an allowable limit of trading for a child, it is possible to prevent the child from purchasing a lot, of commodities before the parent knows in advance. As a matter of course, it is also effective that an adult user sets the allowable limit of trading for himself or herself.

According to the shopping system using a moving picture distribution technique according to claim 7 of the present invention based on the system in any one of the above-described claims 1 to 6, further, the center server comprises a database for setting a trade forbidden condition of the user and means of rejecting the trading when the purchase request of the commodity and the service complying with the trade forbidden condition is transmitted from the dedicated terminal.

For example, if the parent sets a trade forbidden condition on “commodity and service for adults” for the child, it is possible to prevent the child from accessing to the harmful information, commodity and service before the parent knows in advance.

In the meantime, it is also possible to provide means for controlling the commodity and service on which the trade forbidden condition is set not to be stated in a Web page for selection from the beginning in the center server.

According to the shopping system using a moving picture distribution technique according to claim 8 of the present invention based on the system in any one of the above-described claims 1 to 7, further, the center server comprises a database for accumulating a purchasing history information of the commodity and the service by the user and means of generating a Web page for displaying by priority the commodity and the service belonging to the same genre as the commodity and the service that were purchased by the user with reference to the history information when generating the Web page for selecting the commodity and the service.

As a result, the user can immediately access to the commodity and service information with regard to the filed attracting his or her interest.

According to the shopping system using a moving picture distribution technique according to claim 9 of the present invention based on the system in any one of the above-described claims 1 to 7, further, the center server comprises a database for accumulating a distribution history information to the moving picture file for advertisements of the user and means of generating a Web page for displaying by priority the commodity and the service belonging to the same genre as the commodity and the service according to the moving picture file for advertisements that was distributed to the user with reference to the history information when generating the Web page for selecting the commodity and the service.

Also in this case, the user can immediately access to the commodity and service information with regard to the filed attracting his or her interest.

According to the shopping system using a moving picture distribution technique according to claim 10 of the present invention based on the system in any one of the above-described claims 1 to 9, further, the center server may comprise a database for recording a balance of a deposit of the user; means of comparing the price information of the commodity and the service with the balance when the purchase request of the commodity and the service is transmitted from the dedicated terminal and determining availability of settlement; means of transmitting the order information of the commodity and the service to the communication terminal of the commodity and service provider when the settlement is available; and means of subtracting a settlement amount from the balance of the user.

As a result, any risk that a bad debt is caused with respect to fees of the commodity and the service is evaded, so that safeness of the trading is improved.

According to the shopping system using a moving picture distribution technique according to claim 11 of the present invention based on the system in any one of the above-described claims 1 to 10, further, the ID card stores the card information for realizing a credit card function or a debit card function therein; the dedicated terminal may comprise a card reader for reading the card information and means of transmitting the card information to the center server; and the center server may comprise means of transmitting the price information of the commodity and the service and the card information to a host computer of a credit card company or a banking institution when the purchase request of the commodity and the service is transmitted from the dedicated terminal to make a reference about availability of settlement, and means of transmitting the order information of the commodity and the service to the communication terminal of the commodity and service provider when the settlement is available.

Thus, by adding a credit card function or a debit card function to the ID card, convenience of the user and safeness of the trading are improved.

According to the shopping system using a moving picture distribution technique according to claim 12 of the present invention based on the system in any one of the above-described claims 2 to 11, further, the center server may comprise means of extracting regularly or irregularly the optimum moving picture file for advertisements for each user and transmitting it to the dedicated terminal as being related to the user ID; and the dedicated terminal may comprise means of storing the moving picture file for advertisements transmitted from the center server in the hard disk; and means of reading the moving picture file for advertisements related to the user from the hard disk in a spare time when the user is receiving other moving picture file from the center server and of reproducing it through the television set.

As a result, without waiting for request of distribution of a moving picture file for advertisement from the user, the moving picture file for advertisements can be distributed from the center server to the promising user positively, so that activation of the trading can be expected.

This moving picture file for advertisements is distributed every day, for example, at a mid night when a traffic amount of the network is decreased, to the dedicated terminal.

According to the shopping system using a moving picture distribution technique according to claim 13 of the present invention based on the system of the above-described claim 12, further, the center server may comprise a database for accumulating a purchase history information of the commodity and the service by the user and means of extracting a moving picture file for advertisements with related to the commodity and the service belonging to the same genre as the commodity and the service that were purchased by the user by priority with reference to the history information when transmitting the moving picture file for advertisements to the dedicated terminal of each user.

As a result, the user can efficiently view the moving picture file for advertisements with regard to a genre attracting his or her interest. In addition, also for the provider of the moving picture file for advertisements, it is possible to effectively air the advertisements to the promising user.

According to the shopping system using a moving picture distribution technique according to claim 14 of the present invention based on the system of the above-described claim 12, further, the center server may comprise a database for accumulating a distribution history information of the moving picture file for advertisements to the user and means of extracting a moving picture file for advertisements with related to the commodity and the service belonging to the same genre as the commodity and the service that were distributed to the user by priority with reference to the history information when transmitting the moving picture file for advertisements to the dedicated terminal of each user.

Also in this case, the user can effectively view the moving picture file for advertisements with regard to a genre attracting his or her interest. In addition, also for the provider of the moving picture file for advertisements, it is possible to effectively air the advertisements to the promising user.

According to the shopping system using a moving picture distribution technique according to claim 15 of the present invention based on the system in any one of the above-described claims 1 to 14, further, the dedicated terminal may comprise means of transmitting the reproduction achievement information to the center server when it reproduces the moving picture file for advertisements; and the center server may comprise means of storing the reproduction achievement information in a predetermined database as being related to the user; and means of transmitting this reproduction achievement information and the attribution information of the user to the communication terminal of the provider of the moving picture file for advertisements.

As a result, an advertiser can effectively do sales promotions effectively to the highly promising user.

A video rental system using a moving picture distribution technique according to claim 16 of the present invention may comprise a center server, a dedicated terminal connected to the center server via the Internet, and an ID card carried by each user, wherein the center server may comprise a user database for storing the attribution information of each user therein as being related to a user ID and a dedicated terminal ID; a rental video database for storing the information with related to a video that can be rented to a user; a storage apparatus for accumulating a moving picture file of the rental video; means of carrying out authentication processing with reference to the user database when the dedicated terminal transmits the authentication information of the user; means of generating a Web page for selecting a video title with reference to the database and transmitting it to the dedicated terminal; and means of transmitting the moving picture file related to the video title and the expiration date information of the moving picture file to the dedicated terminal when the information selecting a specific video title is transmitted from the dedicated terminal, wherein the dedicated terminal incorporates a hard disk and a card reader therein and is connected to a television set, and the dedicated terminal may comprise means of transmitting the authentication information read by the card reader to the center server and of requiring authentication of the user; means of displaying the Web page for selecting the video title that is transmitted from the center server on a TV screen; input means for selecting the video title displayed on the TV screen; means of transmitting the video title selected by the user to the center server and requiring the distribution of the corresponding moving picture file; means of storing the moving picture file transmitted from the center server in the hard disk; means of displaying an image of the moving picture file on the television screen and outputting a voice through a speaker; and means of deleting the moving picture file within a predetermined time of period when the expiration date of the moving picture file stored in the hard disk comes.

As a result, the user can accept a service of the rental video casually as same as the above-described online shopping.

Further, differently from a conventional rental video, the system is configured in such a manner that the moving picture file of a main body of the video is distributed via the Internet to be displayed on a TV screen, so that this has an advantage that there is no need for the user to go to a rental video shop. Also for a rental video provider, there is an advantage that there is no need to prepare a shop and staffs.

The user can reproduce the moving picture file stored in the hard disk of the dedicated terminal many times till the expiration date comes, and the copy right can be securely protected because the moving picture file is deleted within a predetermined hour after the expiration date.

In the meantime, as same as the above-described online shopping system, this online video rental system can be also configured in such a manner that the moving picture file for advertisements (a promotion video) is transmitted to the user in advance so as to make the user view it, after that, the moving picture file of the main body of the video is transmitted to the dedicated terminal.

According to the video rental system using a moving picture distribution technique according to claim 17 of the present invention based on the system of the above-described claim 16, further, the center server may comprise means of checking if the moving picture file is deleted or not with reference to the interior of the hard disk of the dedicated terminal after the expiration date of the moving picture file; and means of transmitting an instruction to delete the moving picture file to the dedicated terminal.

As a result, effectiveness of protection of the copy right of the moving picture file is secured.

According to the video rental system using a moving picture distribution technique according to claim 18 of the present invention based on the system of the above-described claim 16 or 17, further, the center server may comprise means of transmitting the moving picture file to the dedicated terminal by plural blocks; and the dedicated terminal may comprise means of storing the moving picture file transmitted from the center server in the hard disk by block units; and means of carrying out fast-forwarding reproduction, rewind reproduction, pause, and play back at low speed of the moving picture data included in the transmitted block.

As a result, even if download of the moving picture file is not entirely completed, the user can enjoy the trick play such as fast-forwarding and rewind with respect to the block download of which is completed.

According to the video rental system using a moving picture distribution technique according to claim 19 of the present invention based on the system in any one of the above-described claims 16 to 18, further, the dedicated terminal may comprise means of making a reference about total number of bytes of the moving picture file to the center server prior to the moving picture distribution request; means for recording the total number of bytes notified by the center server; means of recording the number of the received bytes in the database when download of the moving picture file is stopped in the middle of download; means of notifying the center server of the number of the received bytes when download of the moving picture file is started again; and means of storing the continuous data of the moving picture file in the hard disk when it is transmitted from the center server; and the center server may comprise means of transmitting the remaining data of the moving picture file to the dedicated terminal when the number of the received bytes is notified in response to the distribution request of a specific moving picture file from the dedicated terminal.

As a result, even when the download of the moving picture file is stopped because of some cause such as down of the center server, a circuit disturbance, and OFF of a power source of the dedicated terminal or the like, the remaining data except for the transmitted one may be downloaded again and there is no need to download from the first, so that efficient distribution of the moving picture file can be realized.

However, it is highly possible that the last part of the transmitted data includes the unstable data, so that it is preferable that some amount of the transmitted data is also redundantly transmitted upon restart of the download for confirmation.

According to the video rental system using a moving picture distribution technique according to claim 20 of the present invention based on the system of the above-described claim 19, further, the dedicated terminal may comprise means of securing a necessary capacity by deleting the moving picture file in the order corresponding to one close to the expiration date with reference to the expiration date of each moving picture file stored in the hard disk when determining that the hard disk runs out of its capacity upon download of a new moving picture file.

As a result, it is possible to store a new moving picture file continuously in the hard disk of the dedicated terminal capacity of which is limited.

According to the video rental system using a moving picture distribution technique according to claim 21 of the present invention based on the system in any one of the above-described claims 16 to 20, further, the dedicated terminal may comprise a database for recording the information with related to a downloaded moving picture file, a moving picture file download of which is reserved, and a moving picture file deleted as its expiration date remains as being related to the user ID; means of generating a list on which a title and an expiration date of the moving picture file according to the user are stated with reference to the user ID and the database that are read from the card reader; and means of displaying the list on the TV screen.

As a result, a video title list that is specific to each user is generated.

According to the video rental system using a moving picture distribution technique according to claim 22 of the present invention based on the system of the above-described claim 21, further, a mark indicating that the download is not completed is attached to the moving picture file download of which is reserved and the moving picture file deleted as its expiration date remains that are stated in the list, and a mark indication that the download is completed is attached to the downloaded moving picture file; and the dedicated terminal comprises means of requesting distribution of the moving picture file according to the tile of the center server when the user selects the title of the video download of which is not completed on the TV screen.

As a result, the user can also download the moving picture file that is not stored in the hard disk many times according to need within the expiration date to reproduce the file through the television set.

According to the video rental system using a moving picture distribution technique according to claim 23 of the present invention based on the system of the above-described claim 21 or 22, further, the dedicated terminal may comprise means of recording a flag of undisplay with respect to the moving picture file in the database when the expiration date of the moving picture file comes; means of transmitting request to rent the moving picture file again to the center server when the user inputs a request of rental of the moving picture file again within a predetermined time of period; means of recording the expiration date in the database as being related to the moving picture file when the center server notifies a new expiration date; and means of displaying the moving picture file in the list to be downloaded; and the center server may comprise means of notifying the moving picture file of a new expiration date when a request of rental of a specific moving picture file again is transmitted from the dedicated terminal within a predetermined time of period after the expiration date.

In this case, the moving picture file is not deleted immediately after the expiration date but the moving picture file is held in the hard disk during a predetermined window time (for example, five hours).

During this time, a flag of undisplay is raised in the moving picture file, so that this moving picture file is not displayed in the above-described list and the user cannot reproduce the moving picture file.

On the contrary, when the user indicates request of re-rental (normally including a fee of extension) during this time, processing for updating the expiration date with respect to this moving picture file is only carried out. As a result, it becomes unnecessary to download the moving picture file again.

According to the video rental system using a moving picture distribution technique according to claim 24 of the present invention based on the system in any one of the above-described claims 16 to 23, further, the center server may comprise means of, when a request of reservation of download is transmitted from a communication terminal operated by the user via the Internet, transmitting a Web page requiring input of the user ID and a password to the communication terminal, means of transmitting a Web page for selecting a video title to the communication terminal when the user ID and the password are transmitted from the communication terminal of the user; means of generating an electronic mail in which the download reservation information of the video title is stated when the information for selecting a specific video title from the communication terminal is transmitted, and accumulating it in a mail box of the user; and means of transmitting the moving picture file to the dedicated terminal when the request of distribution of a specific video title is transmitted from the dedicated terminal; and the dedicated terminal may comprise means of regularly connecting to the center server and requesting the distribution of the electronic mail with related to the user; means of requesting the distribution of the moving picture file to the center server on the basis of the reservation information stated in this electronic mail when receiving the electronic mail from the center server; and means of storing the moving picture file in the hard disk when the moving picture file is distributed from the center server.

As a result, when the user is away from home, he or she can reserve download of the moving picture file by using a cellular phone, a PDA (Personal Digital Assistant), and a notebook computer provided with the Internet connecting function, so that the user can view the moving picture file that has been downloaded just after he or she comes home.

The video rental system according to the present invention is on the basis that it can reproduce the moving picture file at the same time as downloading it. In addition, when download of one block configuring the moving picture file is completed as described above, it is possible to carry out the trick play such as fast-forwarding and rewind with respect to this block.

However, in order to enjoy the trick play with respect to the entire moving picture file, it is necessary that the moving picture file has been downloaded. Therefore, with respect to a full-length video title requiring a long time for download and a high-quality video title, it is desirable that the user reserves download from a place where the user has gone and the user completes the download when he or she comes home.

According to the video rental system using a moving picture distribution technique according to claim 25 of the present invention based on the system in any one of the above-described claims 16 to 24, further, the dedicated terminal may comprise means of embedding at least one of the user ID and the dedicated terminal ID in each frame composing a moving picture as the watermark information when reproducing the moving picture file that is transmitted from the server.

As a result, even if the moving picture is illegally copied, it is possible to easily specify its runoff source.

According to the video rental system using a moving picture distribution technique according to claim 26 of the present invention based on the system in any one of the above-described claims 16 to 25, further the center server may comprise means of coding the moving picture file and means of transmitting this coded moving picture file to the dedicated terminal.

Thus, by applying encryption processing that can be decrypted only by the intended dedicated terminal to the moving picture file for video rental to be transmitted from the center server, even if the file is intercepted by the third person in the middle of transmission, there is no risk that the copy right is infringed.

According to the video rental system using a moving picture distribution technique according to claim 27 of the present invention based on the system in any one of the above-described claims 16 to 26, further, the center server may comprise a database for setting an allowable limit of trading of the user and means of rejecting the trading when the request to rent the video over the allowable limit of trading of the user is transmitted from the dedicated terminal.

As a result, as same as the case of the online shopping, it is possible to prevent the child from purchasing a lot of commodities before the parent knows in advance.

According to the video rental system using a moving picture distribution technique according to claim 28 of the present invention based on the system in any one of the above-described claims 16 to 27, further, the center server may comprise a database for setting a trade forbidden condition of the user and means of rejecting the trading when the request to rent the video complying with the trade forbidden condition is transmitted from the dedicated terminal.

As a result, if the parent sets a trade forbidden condition on “commodity and service for adults” for the child, it is possible to prevent the child from viewing the harmful information, commodity and service before the parent knows in advance.

In the meantime, it is also possible to provide means for controlling the commodity and service on which the trade forbidden condition is set not to be stated in a Web page for selection from the beginning in the center server.

According to the video rental system using a moving picture distribution technique according to claim 29 of the present invention based on the system in any one of the above-described claims 16 to 28, the center server may comprise a database for accumulating a rental history information of the user and means of generating a Web page for displaying by priority the video title included in the genre that was rented by the user with reference to the history information when generating the Web page for selecting the rental video.

As a result, the user can immediately access to the information of the video with regard to the genre attracting his or her interest.

According to the video rental system using a moving picture distribution technique according to claim 30 of the present invention based on the system in any one of the above-described claims 16 to 29, further, the center server may comprise a database for recording a balance of a deposit of the user; means of comparing the rental fee with the balance when the request to rent the video is transmitted from the dedicated terminal and determining availability of settlement; means of transmitting the moving picture file to the dedicated terminal when the settlement is available; and means of subtracting a settlement amount from the balance of the user.

As a result, any risk that a bad debt is caused with respect to fees of video rental is evaded, so that safeness of the trading is improved.

According to the video rental system using a moving picture distribution technique according to claim 31 of the present invention based on the system in any one of the above-described claims 16 to 30, further, the ID card stores the card information for realizing a credit card function or a debit card function therein; the dedicated terminal may comprise a card reader for reading the card information and means of transmitting the card information to the center server; and the center server may comprise means of transmitting the rental fee information and the card information to a host computer of a credit card company or a banking institution when the request to rent the video is transmitted from the dedicated terminal to make a reference about availability of settlement, and means of transmitting the moving picture file to the dedicated terminal when the settlement is available.

Thus, by adding a credit card function or a debit card function to the ID card, convenience of the user and safeness of the trading are improved.

According to the video rental system using a moving picture distribution technique according to claim 32 of the present invention based on the system in any one of the above-described claims 16 to 31, further, the center server may comprise a storage apparatus for accumulating a moving picture file for advertisements of a commodity and a service, a database for storing the information with related to each moving picture file for advertisements, and means of extracting regularly or irregularly the optimum moving picture file for advertisements for each user and transmitting it to the dedicated terminal as being related to the user ID; and the dedicated terminal may comprise means of storing the moving picture file for advertisements transmitted from the center server in the hard disk; and means of reading the moving picture file for advertisements related to the user from the hard disk in a spare time when the user is receiving the moving picture file of the rental video from the center server and of reproducing it through the television set.

As a result, the moving picture file for advertisements can be distributed from the center server to the promising user positively, so that activation of the trading can be expected.

This moving picture file for advertisements is distributed every day, for example, at a mid night when a traffic amount of the network is decreased.

According to the video rental system using a moving picture distribution technique according to claim 33 of the present invention based on the system of the above-described claim 32, further, the dedicated terminal may comprise means of transmitting the reproduction achievement information to the center server when it reproduces the moving picture file for advertisements; and the center server may comprise means of storing the reproduction achievement information in a predetermined database as being related to the user; and means of transmitting this reproduction achievement information and the attribution information of the user to the communication terminal of the provider of the moving picture file for advertisements.

As a result, an advertiser can effectively do sales promotions effectively to the highly promising user.

According to the video rental system using a moving picture distribution technique according to claim 34 of the present invention based on the system of the above-described claim 32 or 33, further, the dedicated terminal may comprise means of transmitting a purchase request of the commodity and the service to the center server when the user selects the purchase of the commodity and the service according to the moving picture file for advertisements; and the center server comprises means of transmitting the order information of the commodity and the service to the communication terminal of the commodity and service provider when the purchase request is transmitted from the dedicated terminal; the database for accumulating the purchase history of the commodity and the service by the user; and means of extracting by priority the moving picture file for advertisements with related to the commodity and the service belonging to the same genre as the commodity and the service that were purchased by the user with reference to the purchase history information when transmitting the moving picture file for advertisement to the dedicated terminal of each user.

As a result, the user can efficiently view the moving picture file for advertisements with regard to a genre attracting his or her interest. In addition, also for the provider of the moving picture file for advertisements, it is possible to effectively air the advertisements to the promising user.

An interactive system using a moving picture distribution technique according to claim 35 of the present invention may comprise a center server, a plurality of dedicated terminals connected to the center server via the Internet, and an ID card carried by the user; the center server may comprise a user database for storing the attribution information of each user therein as being related to a user ID and a dedicated terminal ID; means of carrying out authentication processing with reference to the user database when each dedicated terminal transmits the user ID and the dedicated terminal ID; means of generating a Web page to prompt to specify a user of a counter part and transmitting it to at least one dedicated terminal; means of transmitting the moving picture file transmitted from the dedicated terminal to other dedicated terminal when the information to specify the counter part is transmitted from one dedicated terminal; and means of transmitting the moving picture file transmitted from other dedicated terminal to one dedicated terminal; and each dedicated terminal may comprise input and output terminals for connecting the dedicated terminal to the television set; input and output terminals for connecting the dedicated terminal to a camera for inputting an image and a microphone for inputting a voice; a card reader for reading the user ID and the dedicated terminal ID that are stored in the ID card; means of transmitting the user ID and the dedicated terminal ID to the center server and requesting the authentication of the user; means of transmitting the image and voice of the user input through a camera and a microphone to the center server by converting them into the moving picture file; and means of displaying the image of the moving picture file from the dedicated terminal of the counter part transmitted from the center server on the TV screen and outputting the voice through the speaker.

As a result, the user can enjoy the video chat casually as same as the above-described online shopping and the online video rental system.

Alternatively, by having a conversation with a staff of the provider of the commodity and the service through this system in the middle of the online shopping, the user can directly make an inquiry to the staff about a point that is not clear only from the moving picture for advertisement.

According to the interactive system using a moving picture distribution technique according to claim 36 of the present invention based on the system of the above-described claim 35, further, the center server may comprise storage means of storing the moving picture file transmitted from the both dedicated terminals.

As a result, it is possible to save the contents of the conversation.

According to the interactive system using a moving picture distribution technique according to claim 37 of the present invention based on the system of the above-described claim 35 or 36, further, each dedicated terminal incorporates a hard disk therein and may comprise means of storing the moving picture file transmitted to the center server and the moving picture file transmitted from the center server in the hard disk.

### BRIEF DESCRIPTION OF THE DRAWINGS

FIG. 1 is a pattern diagram showing an entire image of an interactive moving picture distribution system according to the present invention.

FIG. 2 is a block diagram showing a configuration of hardware of a dedicated terminal.

FIG. 3 is a block diagram showing a structure of a function of the interactive moving picture distribution system.

FIG. 4 is an explanatory view showing an example of a data item to be set in a commodity and service database.

FIG. 5 is an explanatory view showing an example of a data item to be set in a moving picture database.

FIG. 6 is an explanatory view showing an example of a data item to be set in a user database.

FIG. 7 is a layout view showing a state that an opening menu is displayed on a TV screen.

FIG. 8 is a flow chart showing a processing procedure when a user uses an online shopping service.

FIG. 9 is a layout view showing a state that a page for shopping is displayed on the TV screen.

FIG. 10 is a flow chart showing a processing procedure when a user uses a video rental service.

FIG. 11 is a layout view showing a state that a page for a rental video is displayed on the TV screen.

FIG. 12 is an image view showing a manner that digital watermark information is embedded in each frame composing a moving picture.

FIG. 13 is a block diagram showing a structure of a function of a second video rental system.

FIG. 14 is a flow chart showing a processing procedure in the second video rental system.

FIG. 15 is a layout view showing a display example of a video title list.

FIG. 16 is a conceptual illustration showing an example of a server configuration of the second video rental system.

FIG. 17 is a flow chart showing a processing procedure when the user uses a video chat service.

### BEST MODE FOR CARRYING OUT THE INVENTION

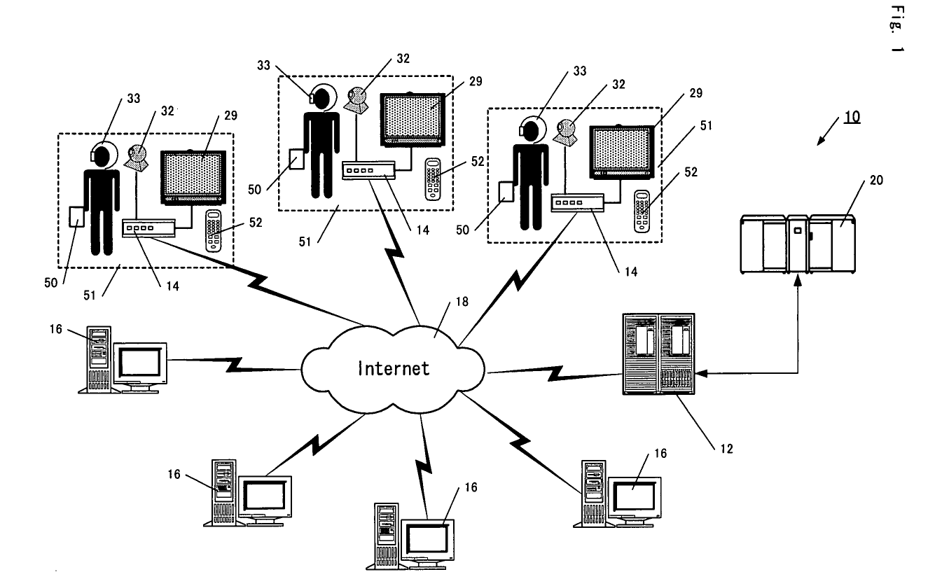

FIG. 1 is an image diagram showing an interactive moving picture distribution system 10 for realizing a shopping system, a first video rental system, and an interactive system according to the present invention, and this interactive moving picture distribution system 10 is provided with a center server 12 managed by an operator of this system, many dedicated terminals (set top box/STB) 14 located at each home, and many local servers 16 managed by a provider who uses this system and offers a commodity and a service to a general user.

The above-described center server 12 is actually formed by connecting a plurality of computers to a network and the center server 12 is provided with a WWW (World Wide Web) server function, a moving picture content distribution server function, a database server function, a mail server function, an authentication server function, a settlement server function, an electronic commerce server function, and a time server function or the like.

The center server 12 and each local server 16 are network-connected with each other through Internet 18, respectively. In the meantime, a business alliance contract or a system usage contract is concluded in advance between an operator of the system and a provider of the commodity or the like.

The center server 12 and each dedicated terminal 14 are also network-connected with each other through Internet 18, respectively. Here, the dedicated terminal 14 is connected to the Internet 18 via the server of an Internet service provider (ISP) (not illustrated). In addition, the server of the ISP is continuously connected with the dedicated terminal 14 via a so-called broadband network of high speed and high capacity such as an ADSL and an optical fiber.

The center server 12 is also connected with the host computers 20 of a credit card company and a banking institution via a settlement network such as a CAFIS or the like.

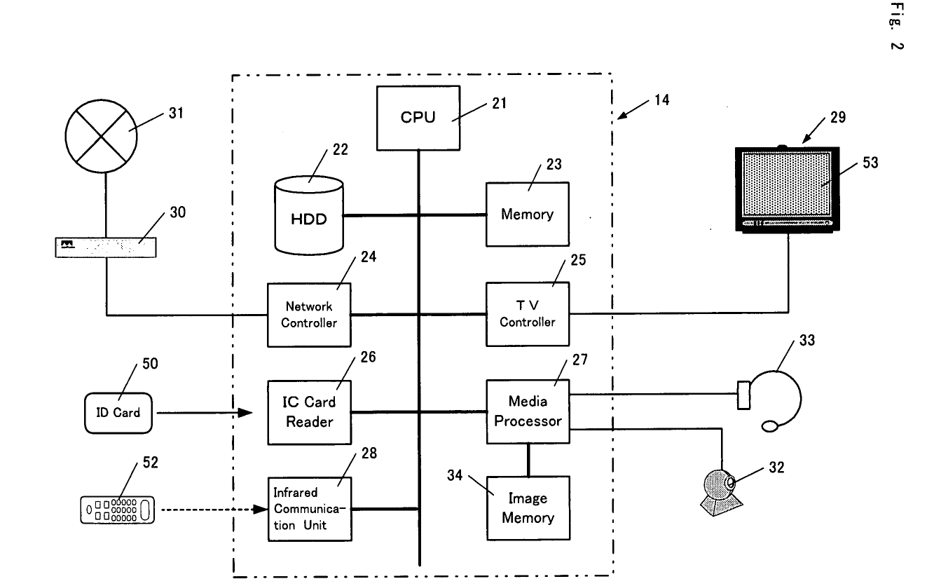

FIG. 2 is a block diagram showing a configuration of hardware of the dedicated terminal 14, and the dedicated terminal 14 is provided with a CPU 21, a hard disk 22 that is connected with the CPU 21 via a system bus, a memory (ROM, RAM) 23, a network controller 24, a TV controller 25, an IC card reader 26, a media processor 27, and an infrared communication unit 28.

A general television set 29 is connected with the above-described TV controller 25 via input and output terminals and a connection cable.

In addition, a broadband modem 30 is connected with the network controller 24, and the network controller 24 is connected with the Internet 18 via this broadband modem 30 and a broadband network 31.

Further, a CCD camera set 32 and a head set (a head phone, a microphone) 33 are connected with the media processor 27 via a dedicated port. This media processor 27 functions to encode and decode the moving picture data and the voice data in real time, and a memory 34 dedicated for the image processing is connected with the media processor 27.

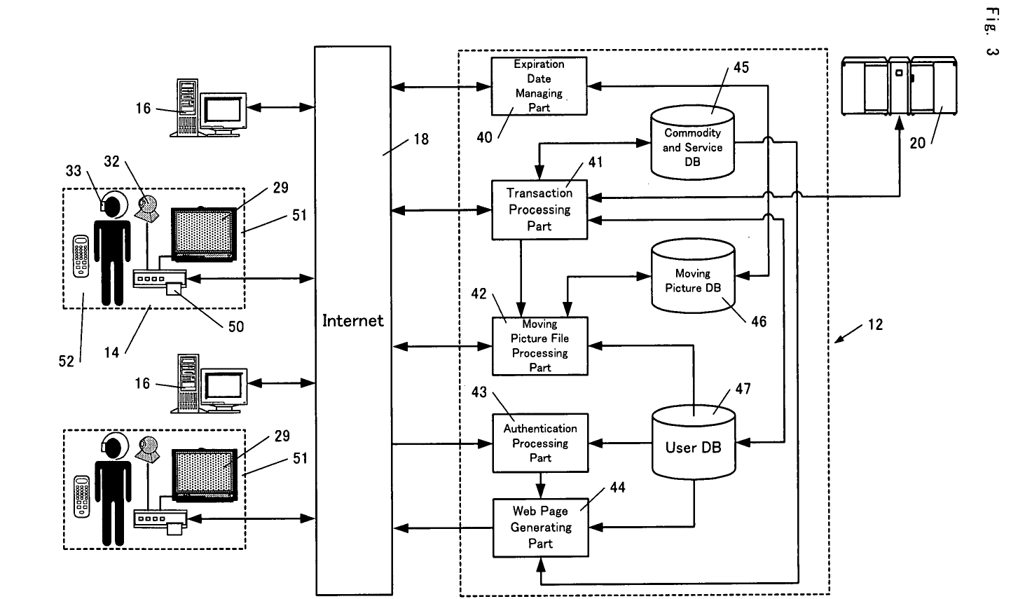

FIG. 3 is a block diagram showing a structure of a function of this interactive moving picture distribution system 10, and the center server 12 is provided with an expiration date managing part 40, a transaction processing part 41, a moving picture file processing part 42, an authentication processing part 43, a Web page generating part 44, a commodity and service data base 45, a moving picture database 46, and a user database 47.

The above-described expiration date managing part 40, transaction processing part 41, moving picture file processing part 42, authentication processing part 43 and Web page generating part 44 are executed when the CPU of the computer configuring the center server 12 carries out the necessary processing according to an OS and a dedicated program.

In addition, the commodity and service database 45, the moving picture database 46, and the user database 47 are stored in a hard disk of the above-described computer.

In the commodity and service database 45, the information according to the commodity and the service to be supplied from the commodity and service provider to the user through this system 10 is stored.

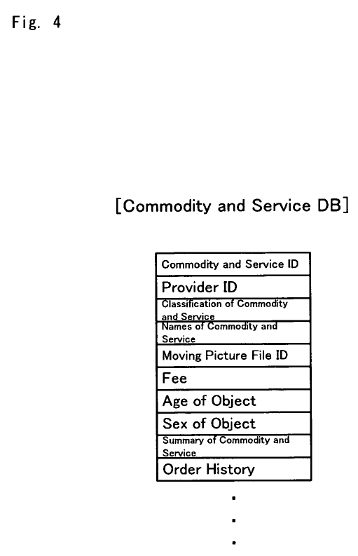

FIG. 4 is an explanatory view showing an example of a data item to be set in the commodity and service database 45, and in this database 45, with putting “a commodity and service ID” at the head, the items such as “a provider ID”, “a classification of a commodity and a service”, “names of a commodity and a service”, “a moving picture file ID”, “a fee”, “an age of an object”, “a sex of an object”, “a summary of a commodity and a service”, and “an order history” or the like are set.

Among these, the “names of a commodity and a service”, “a fee”, “age of object”, and “summary of commodity and service” can be arbitrarily set by the provider as a general rule except for the case of being offensive to public order and morals.

On the contrary, it is necessary to set “classification of a commodity and a service” in accordance with a classification (type) system that is defined at the side of the system operator in advance. This classification system includes a hierarchy structure, and for example, with respect to the rental video provider, the following classification systems are prepared.

[Rental Video]→[Movie]→[Foreign Movie/Japanese Movie]→[Genre (discrimination of Adult, Animation, Historical Drama, and Western Film or the like)]

[Rental Video]→[Baseball]→[Genre (Professional Baseball, Major League Baseball, College Baseball/High School Baseball) or the like]

In the meantime, only in the case of the video rental provider, the ID information with regard to the moving picture file of the main body of the renal video is stated in the “moving picture file ID”.

In addition, with regard to the online shopping provider, the following classification system is prepared.

[Shopping]→[Genre 1 (an upper class of PC, Clothing, Liquor, Food or the like)]→[Genre 2 (a middle class of Desk Top-type, Notebook-type, PDA, and Peripheral Device or the like)]→[Genre 3 (a lower class of Printer, Scanner, Drive, and Memory or the like)]

As a matter of course, these classification systems are one example of the classification system and a specific level may be decided in consideration of convenience of the user and complication of the provider.

The “age of an target” is based on the self-assessment information of the provider, however, the video for adults or the like may be also checked by the system operator.

The moving picture database 46 stores the information with related to the moving picture file to be treated in this system 10 (the moving picture advertisement file and the moving picture file of the rental video main body) therein.

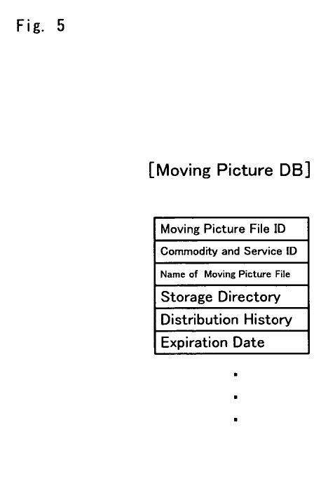

FIG. 5 shows an example of a data item to be set in the moving picture database, and in this database, with putting “a moving picture file ID” at the head, the items such as “a commodity and service ID”, “a name of a moving picture file”, “a storage directory”, “a distribution history”, and “an expiration date” or the like are set.

In the “expiration date”, an absolute expiration date such as “Dec. 31, 2002” can be set, however, a relative expiration date such as “within three days after dispatch” also can be set.

In the meantime, the moving picture file itself is encoded on the basis of a standard such as an MPEG 4 and an MPEG 2 or the like in the system in advance to be stored in a predetermined directory of a hard disk.

In addition, the illustration is omitted here, however, it is preferable that an item to state a capacity (the number of byte) of the moving picture file is set.

In the database 47, the information with regard to a registered user of this system 10 is stored.

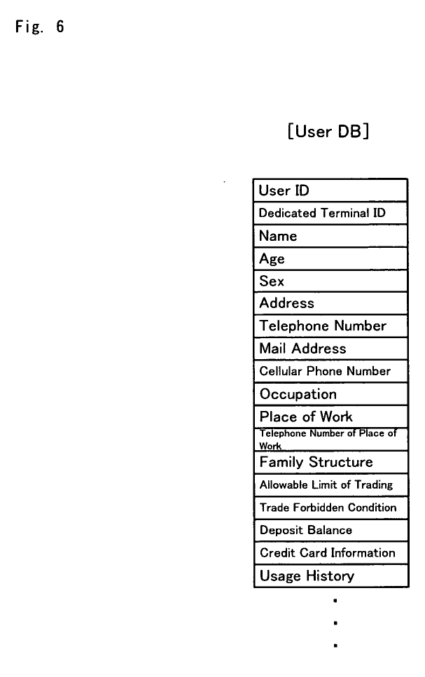

FIG. 6 shows an example of a data item to be set in the user database, and in this database, with putting “a user ID” at the head, the items such as “a dedicated terminal ID”, “a name”, “an age”, “a sex”, “an address”, “a telephone number”, “a mail address”, “a cellular phone number”, “an occupation”, “a place of work”, “a telephone number of a place of work”, “a family structure”, “an allowable limit of trading”, “a trade forbidden condition”, “a deposit balance”, “a credit card information”, and “a usage history” or the like are set.

The user who wants to use this system 10 newly subscribes the service through a shop near him or her. Specifically, the user is required to state the attribution information such as his or her name, age, sex, address, telephone number, mail address, cellular phone number, occupation, place of work, address of a place of work, and family structure or the like and the information on the credit card or the like in a predetermined application form.

Then, the dedicated terminal 14 and an ID card 50 are issued to the user with the provision that all necessary items are filled in the application form and the user agrees with a predetermined contract clause (promising that, for example, the contract clause that the user does not connect the dedicated terminal to the network at a place other than the declared place such as his or her own home and the user does not lend the ID card to others or the like). Upon this subscription procedure, it is also possible to impose on the user presentation of a driver's certification, a student card, and a health insurance card or the like.

A specific ID (MAC address) is allocated to the dedicated terminal 14. In addition, the ID card 50 incorporates an IC memory and in this IC memory, the ID of the dedicated terminal 14 is also stored together with the ID of the user.

When children of the user subscribe this system, the user can state “the allowable limit of trading” and “the trade forbidden condition” in the above-described application form as a special affair.

For example, when the allowable limit of trading of “3,000 yen” per month is set for the child user, if this child user tries to purchase the commodities over 3,000 yen per month, the transaction processing part 41 transmits a warning message such as “over the allowable limit of trading” to reject this transaction. As a result, it is possible to prevent the child from purchasing a lot of commodities before the parent knows in advance.

In addition, when the trade forbidden condition of “elimination of programs for adults” is set for the child user, even if this child user orders rental of a video that is classified as adult or orders purchase of the adult goods, the transaction processing part 41 may detect this to reject this transaction. Alternatively, when the child user uses the system, it is also possible to control the information of the program for adults not to be displayed in a service menu from the beginning by using the transaction processing part 41. As a result, the child user can be protected from the harmful information.

The contents stated in the above-described application form are stored in the user database 47 by the system operator.

As described above, in place of carrying out the subscription procedure at the shop, the user also can subscribe the system by accessing to the Web site of the center server 12 from the PC via the Internet 18 and inputting the necessary items in a predetermined input form. In this case, the dedicated terminal 14 is delivered to the user's own home through a home delivery service.

In the meantime, when a family member living together with the user subscribes the system, each user ID is related to one dedicated terminal 14.

After completion of the subscription procedure, installing the dedicated terminal 14 at his or her own home 51, the user connects the dedicated terminal 14 to the broadband modem 30 via a LAN cable and connects it to the television set 29 via an AV cable. In addition, according to need, the user may connect the CCD camera set 32 and the head set 33 to a plug of the dedicated terminal 14.

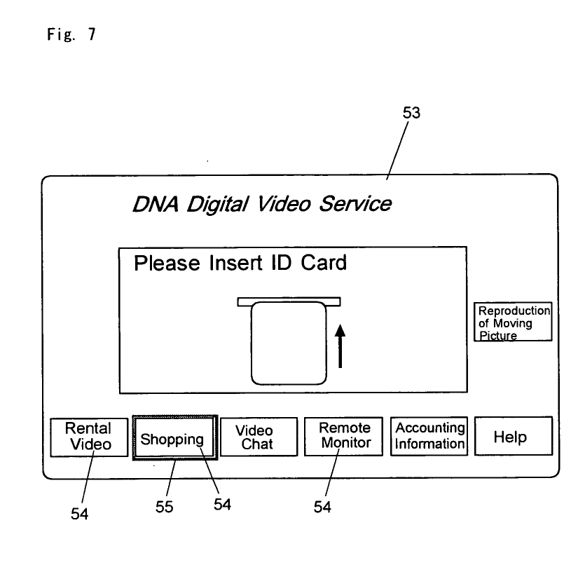

In this case, if the user powers ON the power sources of the dedicated terminal 14 and the television set 29 and operates a remote controller 52 to tune the television set 29 to a dedicated channel, a control program and a dedicated Web browser program are activated, which are stored in the memory 23 of the dedicated terminal 14 and the hard disk 22. Then, as shown in FIG. 7, a message to prompt insertion of the ID card 50 is displayed on a screen 23 of the television set 29.

In accordance with this, if the user inserts his or her own ID card 50 into a card slit of the dedicated terminal 14, the user ID in the IC memory is read by the IC card reader 26.

At the same time, an initiation signal is outputted to the IP address of the center server 12 from the dedicated terminal 14. Receiving this, the authentication processing part 43 of the center server 12 may raise a flag of “initiation” with respect to the MAC address of this dedicated terminal 14 in the database of the dedicated terminal (not illustrated).

In addition, with reference to the user database 47, the authentication processing part 43 may check that the user ID related to this dedicated terminal 14 complies with the user ID of the ID card 50.

After clearing this authentication step, the user can select menu buttons 54 listed in a lower column of a screen 53.

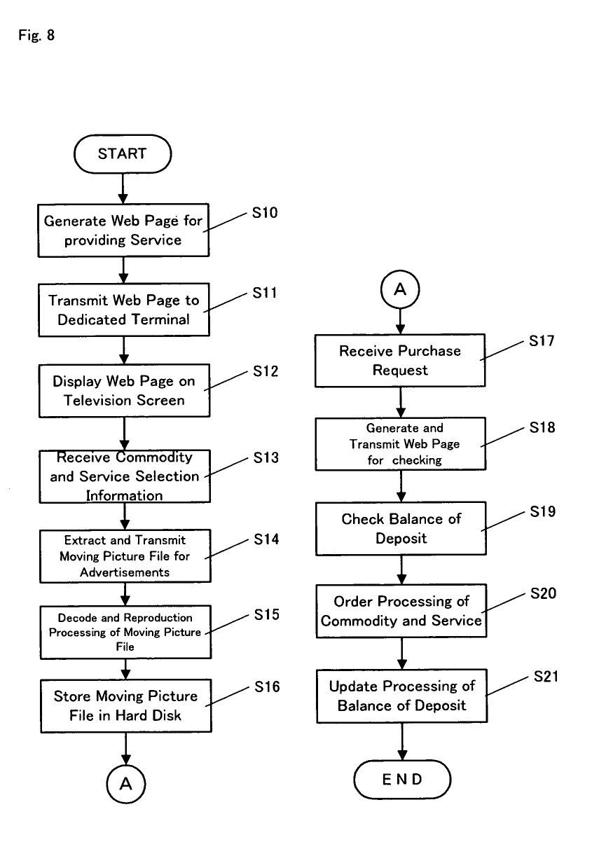

Hereinafter, in accordance with the flow chart shown in FIG. 8, a processing procedure when the user uses this system 10 as the online shopping system will be described below.

At first, if the user operates the remote controller 52 to match a selection frame 55 with a “shopping” button 54 and pushes down a decision key, a Web page for providing an online shopping service is generated by the Web page generating part 44 (S10) to be transmitted to the dedicated terminal 14 via the Internet 18 (S11).

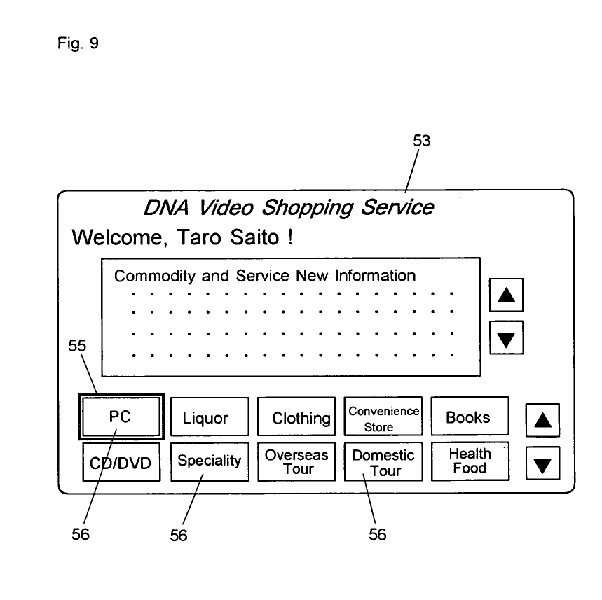

As a result, as shown in FIG. 9, a page for shopping on which many buttons for selecting a service 56 are located is displayed on the television screen 53 (S12).

In these buttons for selecting a service 56, “the commodity and service classification” is stated, and the user may selects the necessary button 56 from among these buttons by the remote controller. If the corresponding button is not found in the list, by selecting a button of “0” and scrolling down, the user also can search for the intended commodity or service.

For example, if the user selects “PC” from among the above-described buttons for selection 56, the Web page generating part 44 makes the Web page on which the middle class (Desk Top-type, Notebook-type, PDA, and Peripheral Device or the like) included in the “PC” is listed to be displayed on the television screen 53 so as to prompt the user to select the button.

On the contrary, if the user selects the “Desk Top-type”, the Web page generating part 44 extracts the commodity and service information that is classified as “Desk Top-type” from the commodity and service data base 45 to display the commodity selection page on which plural commodity names, manufacturer names, model numbers, and prices or the like are listed on the television screen 53.

If the user selects a specific desk top-type PC from among them, with reference to the moving picture database 46, the moving picture file processing part 42 (S13) having received this extracts the moving picture file for advertisements with regard to the commodity ID and may stream-distribute it to the dedicated terminal 14 via the Internet 18 (S14). In this case, the data of the moving picture file is divided into a plurality of block units (for example, one block is equal to 500 k byte) to be transmitted to the dedicated terminal.

Receiving this, in the dedicated terminal 14, the distributed moving picture data in the MPEG 4 is decoded (decoded and extracted) by a moving picture reproducing program so that the image of the moving picture advertisement is displayed on the television screen 53 in real time (S15). In addition, from a speaker of the television set 29, voice is outputted.

In the dedicated terminal 14, in parallel with streaming reproduction, the moving picture and voice data are stored by block units in the hard disk 22 (S 16). As a result, after viewing the moving picture advertisement for several minutes, the user may rewind the moving picture advertisement that is downloaded in the hard disk 22 and reproduce it so as to check it many times.

A time needed to download this moving picture file is different depending on the data amount of the moving picture file and a communication environment at the user side. In the case that the dedicated terminal 14 is connected to a circuit of a high speed and a high capacity line such as a FTTH using the optical fiber, the download is competed in the middle of the streaming reproduction, so that hereinafter, the rewind reproduction and the pose operation are possible.

Therefore, it is preferable that an icon and a message for identifying “during downloading” or “downloaded” are synthesized and displayed on the television screen 53.

As a result of viewing the moving picture advertisements, the user who decides the purchase controls a cursor button of the remote controller 52 to match the selection frame with the “purchase” button on the screen 53 and pushes down a decision button.

This commodity selection information is transmitted to the center server 12 via the Internet 18.

Receiving this, the Web page generating part 44 (S17) may generate a checking page clearly stating the commodity name and the price and may transmit it to the dedicated terminal 14 to display it on the television screen 53 (S18).

On the contrary, if the user selects the “check” button on the screen 53, the transaction processing part 41 checks the balance information in the user database 47 (S19), and if the balance is enough, the transaction processing part 41 describes the order information in the record in the commodity and service data base 45 and at the same time, it transmits the commodity order information to the local server 16 of the provider of the commodity (S20).

In this order information, the user's name, address, and telephone number data stored in the user database 47 are attached together with the commodity ID. As a result, receiving the order information, the local server 16 of the provider of the commodity can output a distribution command immediately to a distribution server in one's own company.

After that, the transaction processing part 41 updates the balance obtained by subtracting the commodity price from the above-described balance and registers it in the user database 47 as a new balance (S21).

As a settlement method of the price, as described above, a so-called amount system to subtract the price from the deposit paid by the user in advance is employed, so that there is no risk that no settlement of the price is caused.

In the meantime, if the deposit shorts, the user can increase the balance by bringing cash with him or her to a shop which is an agent near the user. Alternatively, the user also can increase the balance by a bank transfer and settlement by a credit card.

As a matter of course, the user also can perform settlement by a credit card each time he or she purchases the commodity in addition to the above-described deposit system.

In this case, displaying a settlement method selection page after the above-described transaction checking page, the transaction processing part 41 makes the user to select the credit card settlement.

Receiving this credit card settlement selection information, the transaction processing part 41 may transmit the card number and the settlement amount information to the host computer 20 of the credit card company of which the user is a member to make a reference about availability of settlement.

Then, when a telegram message of payable is transmitted form this computer 20, the same commodity order information as above is carried out.

By adding a credit card function or a debit card function to the ID card 50 of each user, it is also possible to simplify the processing of settlement of the price.

In this case, employing a type that the CPU is incorporated other than the memory as the ID card 50, a program for realizing the credit card function and the debit card function and the card information (a card number, a code number or the like) are stored in the memory. In addition, the information for identifying the dedicated terminal of each user is also stored in the memory.

As a result, at a time when the user inserts the ID card into the card slit of the dedicated terminal 14, the card information of the user is read by the IC card reader 26 of the dedicated terminal 14 to be transmitted to the center server 12. On the contrary, when inserting the ID card into other dedicated terminal, access to the card information is rejected by the CPU in the card, so that safeness against theft and fabrication of the ID card is secured.

After that, when the user selects the credit card at the settlement method selection page, the transaction processing part 41 may transmit the card number and the settlement amount information to the host computer 20 of the credit card company to make a reference about availability of settlement. If the telegram message of payable is transmitted from this computer 20, the same commodity order information as above is carried out.

When the user selects the debit card at the settlement method selection page, the transaction processing part 41 may transmit the card number, the code number, and the settlement amount information to the host computer of the banking institution to ask withdrawal for the debit card settlement from the user's bank account. Then, in the case that the telegram message of completion of settlement is transmitted from this computer, the same commodity order information as above is carried out.

In the meantime, the code number can be inputted by the user via the remote controller 52 each time of settlement.

The purchase history information of the commodity and the service of the user and the distribution history information of the moving picture file for advertisements to the user are stored in the user database 47 each time together with the date information.

By using the history information and the attribution information accumulated in this user database 47, it is possible to carry out the effective marketing.

For example, when the user accesses to the center server 12, the Web page generating part 44 checks the history information in the user database 47, generates the Web page on which the commodity information of the genre that the user frequently purchases and views the moving picture for advertisements is provided on a top item of a new information column, and displays this Web page on the television screen 53.

In addition, it is also effective to reflect the above described history information at a place where the selection button 56 is located to be displayed on the online shopping offering page shown in FIG. 9. In other words, the buttons 56 are arranged in the order of higher purchase actual achievement by the user or by generating the selection button of “PDA” to the user frequently viewing the moving picture for advertisements with respect to the PDA included in a lower conception of “PC”, this selection button is arranged at a top of the menu.

The commodity and service provider also can develop the rental video business by using this system 10 as the rental video system.

In this case, at first, a rentable video title is registered in the service database 45. In this case, “rental video” is stated as an upper conception of the commodity and service classification item, and a specific title name is stated for the commodity and service names, a rental fee for the fee, and an age limit information such as “20 years and over” for the age of the object, respectively. In addition, in the commodity and service summary item, a catch phrase or the like of the video is stated.

At the same time, in the moving picture database 46, the information with regard to the moving picture file of the main body of the video is registered. In this case, in the item of “expiration date”, a rentable period (for example, three days) is stated.

In addition, in the case that there is a moving picture file of advertisements (a promotion video) with regard to the video, the information with regard to this file is also stored in the moving picture database 46.

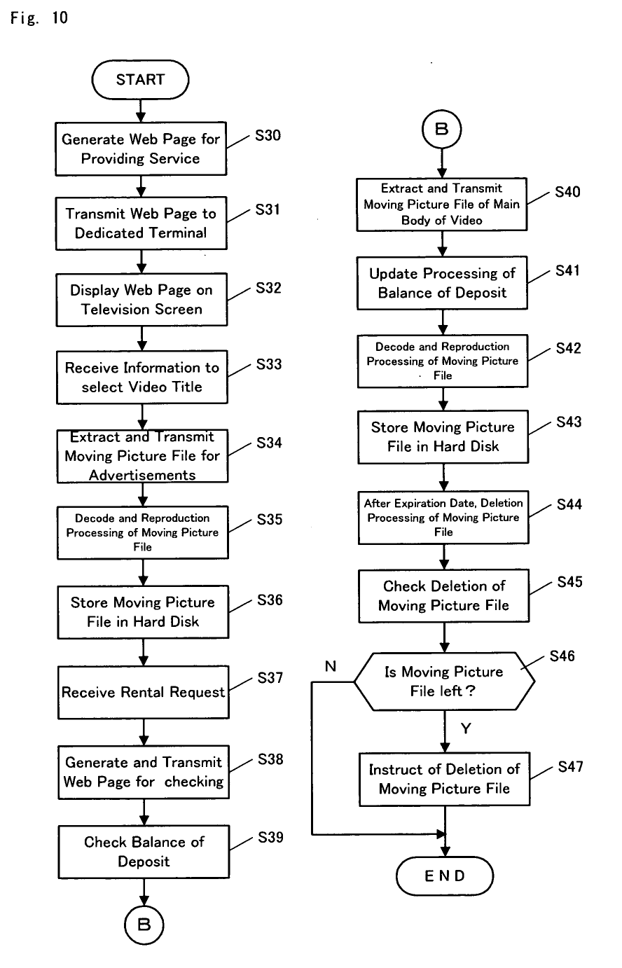

In accordance with the flow chart shown in FIG. 10, a processing procedure when the user uses a video rental service will be described below.

In other words, the user who wants the online distribution of the rental video selects the “rental video” button 54 from the opening menu shown in FIG. 7.

Receiving this, the Web page generating part 44 may generate the Web page for providing the video rental service (S30) and may transmit the generated Web page to the dedicated terminal 14 via the Internet 18 (S31).

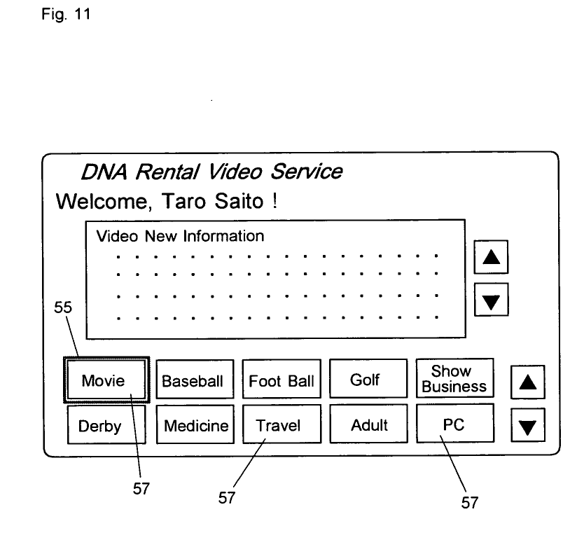

As a result, as shown in FIG. 11, the page for the rental video on which many buttons for selecting the genres of the vide 57 are located is displayed on the television screen 53 (S32).

In these buttons for selecting a service 57, the genre of the video as the object of rental is stated, and the user may selects the necessary button 57 from among these buttons by the remote controller. If the corresponding button 57 is not found in the list, by selecting a button of “0” and scrolling down, the user also can search for the intended genre.

For example, if the user selects “movie” from among the above-described buttons for selection 57, the user arrives at the list screen on which specific video title, rental fee, rental expiration date, and reproduction time or the like are listed via the selection screens of “Foreign Movie” and “Japanese Movie” and the lower genre selection screen of the video.

If the user selects a specific video title from among these, receiving this, with reference to the moving picture database 46, the moving picture file processing part 42 (S33) may extract the moving picture file for advertisements with regard to the commodity and service ID of this rental video and may stream-distribute it to the dedicated terminal 14 via the Internet 18 (S34).

In the dedicated terminal 14, the distributed moving picture data in the MPEG 4 is decoded (decoded and extracted) by a moving picture reproducing program so that the promotion image of the movie is displayed on the television screen 53 in real time (S35). In addition, from the speaker of the television set 29, the corresponding voice is outputted.

In the dedicated terminal 14, in parallel with streaming reproduction, the moving picture and voice data are stored by block units in the hard disk 22 (S 36).

As a result of viewing this moving picture for advertisements, the user who decides to rent the video controls the cursor button of the remote controller 52 to match the selection frame with the “rental” button on the screen and pushes down the decision button.

This rental selection information is transmitted to the center server 12 via the Internet 18.

Receiving this, the Web page generating part 44 (S37) may generate a checking page clearly stating the video title, the rental fee, and the expiration date or the like to display on the television screen 53 (S38).

On the contrary, if the user selects the “check” button on the screen 53, the transaction processing part 41 checks the balance information in the user database 47 (S39), and if the balance is enough, the transaction processing part 41 states the order information in the record in the commodity and service data base 45 and at the same time, on the basis of the instruction of the transaction processing part 41, the moving picture file processing part 42 extracts the moving picture file of the main body of the video from a predetermined directory and may streaming-distribute it to the dedicated terminal 14 via the Internet 18 (S40).

After that, the transaction processing part 41 updates the balance obtained by subtracting the rental fee from the above-described balance and registers it in the user database 47 as a new balance (S41).

In the dedicated terminal 14, a dedicated moving picture reproduction program is activated and the distributed moving data in the MPEG 4 is decoded. As a result, the image of the video is displayed on the television screen 53 in real time and at the same time, from the speaker, the voice is reproduced (S42).

In the dedicated terminal 14, in parallel with the streaming reproduction of the video, the moving picture data of the video are sequentially stored in the hard disk 22 (S43) As a result, after viewing the vide of several tens minutes to two hours in real time, the user can reproduce and view the video downloaded in the hard disk 22 many time till the expiration date comes.

As described above, the expiration date is set in the moving picture file of the main body of the video in advance and the expiration date information is also transmitted to the dedicated terminal 14 together with the moving picture file of the main body of the video.

As a result, in accordance with the expiration management program, the CPU 21 of the dedicated terminal 14 monitors the time data to be outputted from a clock circuit just after this moving picture file is stored in the hard disk 22. Then, when the expiration date comes, the moving picture file in the hard disk 22 is immediately deleted (S44).

This monitoring of the expiration date is carried out also in the expiration date managing part 40 of the center server 12, and after the expiration date comes, checking the hard disk 22 of the dedicated terminal 14 via the Internet 18, the CPU 21 checks if the moving picture file is deleted or not (S45).

Then, when it is not deleted because of some cause (S46), a signal to instruct deletion is transmitted to the dedicated terminal 14 to certainly delete it (S47).

The hard disk 22 of each dedicated terminal 14 is commonly connected to the center server 12 so as to be capable of being fully accessed, so that the expiration date managing part 40 can check each dedicated terminal 14 about existence of the moving picture file and at the same time, it can delete it.

Thus, a double deletion function is provided in such a manner that the expiration date information is related to the moving file, the moving picture file is spontaneously deleted at the side of the dedicated terminal 14 after the expiration date comes, the expiration date is also managed at the side of the center server 12, and deletion is instructed when the missing of deletion is found after the expiration date comes. As a result, the moving picture file of the rental video is certainly erased after the expiration date, so that it is possible to secure the effectiveness of protection of the copy right of the moving picture file.

The above-described dedicated terminal 14 is not provided with an I/O port for taking out the information in the hard disk 22 differently from a general PC, and the information itself is coded and accumulated, so that it is not possible to simply copy and reuse the moving picture file.

In addition, if the power source of the dedicated terminal 14 is powered OFF and the hard disk 22 is taken out forcedly, the center server 12 can detect this. Therefore, the system operation staff immediately makes an inquiry or warns through a telephone, an electronic mail, or the like.

Accordingly, there is little risk that the moving picture file is illegally copied in the above-described expiration date, however, this system is provided with a function for specifying a runoff source for confirmation.

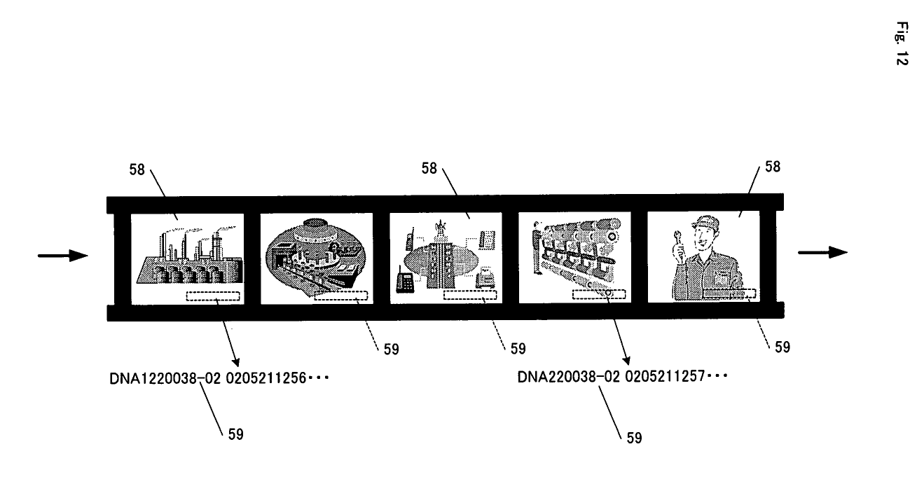

In other words, when the decoding processing of the moving picture data is carried out by the media processor 27 of the dedicated terminal 14, as shown in FIG. 12, the invisible watermark information 59 that is embedded in each frame 58 composing the moving picture.

In this case, as the watermark information 59 to be embedded, for example, the ID of the dedicated terminal 14, the user ID, the moving picture file ID, and the date information of download are available.

As a result, even if the moving picture file accumulated in the hard disk 22 of the dedicated terminal 14 is illegally copied and flows out, by scanning this moving picture file by a dedicated detection program, the watermark information 59 becomes visible.

This watermark information 52 includes the dedicated terminal ID, the user ID, the moving picture file ID, and the date information of download as described above, so that it is possible to easily specify the runoff source of the illegal copy.

Since the watermark information 59 are incused in all frames 58 composing the moving picture file, even in the case that the moving picture file is partially duplicated as a static image, the runoff source can be specified in the same way.

As described above, in the rental video service using this system 10, the moving picture file is downloaded into the dedicated terminal 14 of the user once, so that the user can repeatedly enjoy it till the expiration date comes.

Further, since the moving picture file is certainly erased at the same time as arrival of the expiration date, even if this moving picture file is stored in the hard disk 22, there is no occurrence of the problem to infringe the copyright. On the contrary, in the case of the conventional streaming-distribution, at the request of protection of the copyright, the user has to discard the moving picture data at the same time as reproduction, so that convenience of the user is spoiled.

In addition, also for the provider, there is an advantage that they can freely open the online rental video service because they do not have to open a store and employ a staff. As a result, it is also possible to perform the rental video business with respect to a miner video title such as a live telecast of a baseball game, show business news, and a TV drama, which are difficult to distribute conventionally.

In the meantime, upon transmitting the moving picture data from the center server 12 to the dedicated terminal 14, the predetermined coding processing is applied to the moving picture data and this can be decrypted only by the intended dedicated terminal 14, so that even if a malicious third person abstracts the moving picture data in the middle of transmission, a profit of an owner of copyright is not damaged.

It is preferable that the system is operated in such a manner that the expiration date is set also to the moving picture file for service advertisements, as same as the moving picture file of the main body of the rental video, a system whereby the moving picture file is certainly erased by the center server 12 and the dedicated terminal 14 after the expiration date is prepared, and the watermark information is provided in the decoding processing by the dedicated terminal 14.

When other user at home uses this system, the user may insert his or her own ID card 50 into the slit of the dedicated terminal 14.

As a result, a menu screen dedicated for this user is formed through the Web page generating part 44 to be displayed on the TV screen 53.

The case that the moving picture file for advertisements is distributed to the dedicated terminal 14 from the center server 12 in response to the distribution request from the user is described above, however, it is also possible to positively distribute the moving picture file for advertisements from the center server 12 to the dedicated terminal 14.

For example, during lowering of the traffic amount of the communication network, for example, at a mid night, the moving picture file processing part 42 extracts one or a plurality of the moving picture files for advertisements from the hard disk for each user to push-distribute it to the corresponding dedicated terminal 14 via the Internet 18.

In this case, with reference to the user database 47, the moving picture file processing part 42 may extract and distribute the moving picture files for advertisements of the genre, of which commodities this user frequently purchase or of which moving picture file for advertisements this user frequently views.

In the dedicated terminal 14 receiving this, in accordance with a dedicated control program, this moving picture file for advertisements is accumulated in the hard disk 22.

Then, in a spare time when the user is downloading the moving picture file for the rental video and other moving picture file for advertisements from the center server 12 at the next day (from over ten to several tens seconds), this moving picture file for advertisements is reproduced by the control program of the dedicated terminal through the television set.

As a result, the user can view the moving picture advertisement of the field which he or she is interested in during a short waiting period till the moving picture is reproduced.

If reproduction of this moving picture file for advertisements is completed, the information indicating the completion of the reproduction is transmitted from the dedicated terminal 14 to the center server 12.

In the center server 12 receiving this, this reproduction achievement information is registered in the user database 47 by the transaction processing part 41. In addition, this reproduction achievement information and the attribution information of the user (the name, the electronic mail address, and the address or the like) are transmitted to the local server 16 of the commodity and information provider (when the user agrees).

The commodity and information provider can perform the effective sales promotion by transmitting the electronic mail and the DM on the basis of this information.

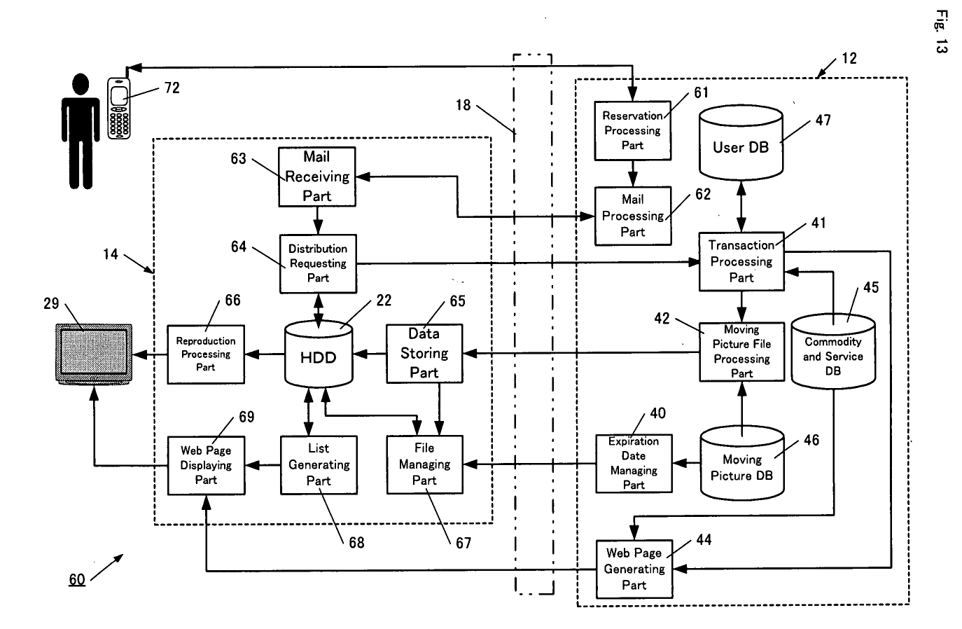

FIG. 13 is a block diagram showing a structure of a function of a video rental system according to other embodiment.

In the case of this second video rental system 60, the center server 12 is characterized by being provided with a reservation processing part 61 and a mail processing part 62 and other functional structures are substantially the same as the center server 12 in the above-described system 10 (however, as a matter of convenience for illustration, the illustration of the authentication processing part 43 is herein omitted).

On the contrary, the above-described CPU 21 and the media processor 27 are operation accordance with the OS and the dedicated program, so that the dedicated terminal 14 is provided with a mail receiving part 63, a distribution requesting part 64, a data storing part 65, a reproduction processing part 66, a file managing part 67, a list generating part 68, and a Web page displaying part 69.

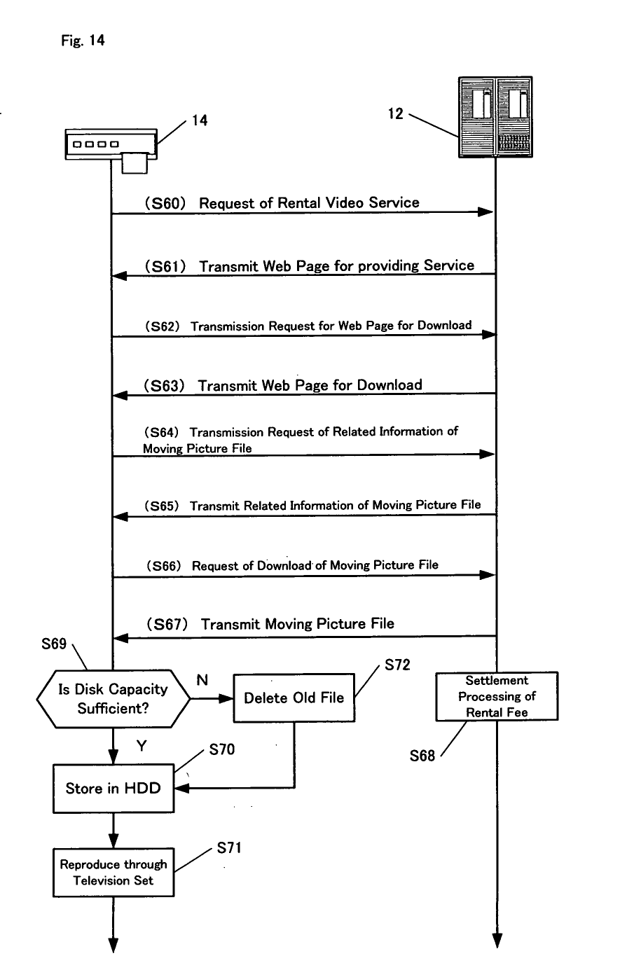

Hereinafter, in accordance with the flow chart shown in FIG. 14, a processing procedure when the user uses this second video rental system 60 will be described below.

At first, the user who wants the online distribution of the rental video may select the “rental video” button 54 from the opening menu shown in FIG. 7 as same as the above. As a result, a transmission request of the Web page for the rental video service is outputted from the distribution requesting part 64 of the dedicated terminal 14 to the center server 12 (S60).

Receiving this, the Web page generating part 44 may generate the Web page to be provided for the video rental service and may transmit it to the dedicated terminal 14 via the Internet 18 (S61).

As a result, as shown in FIG. 11, the page for the rental video on which many buttons for selecting the genres of the vide 57 are located is displayed on the screen of the television set 29.

On the contrary, if the user selects “movie”, the user arrives at the list screen on which specific video title, rental fee, rental expiration date, and reproduction time or the like are listed via the selection screens of “Foreign Movie” and “Japanese Movie” and the lower genre selection screen of the video.

If the user selects a specific video title from among these, the transmission request of the Web page for download is outputted from the distribution requesting part 64 to the center server 12 (S62).

Receiving this, the transaction processing part 41 transmits the Web page for download to the dedicated terminal 14 through the Web page generating part 44 (S63).

Receiving this, the Web page displaying part 69 of the dedicated terminal 14 may display this Web page for download on the screen of the television set 29. On this Web page for download, the title, the expiration date, and the rental fee or the like of the video that is selected by the user are stated.

In addition, a transmission request of the related information such as the file size (total number of bytes), the expiration date, and the title of this moving picture file for the rental video is outputted from the distribution requesting part 64 of the dedicated terminal 14 to the transaction processing part 41 (S64).

Receiving this, the transaction processing part 41 may transmit the related information recorded in the moving picture database 46 via the moving picture file processing part 42 (S65).

The data storing part 65 states these information in a download database (not illustrated) that is provided in the hard disk 22.

After checking the content of the above-described Web page for download, if the user selects the button stated as “to rent” by the remote control operation, the download request of this moving picture file is outputted from the distribution requesting part 64 to the transaction processing part 41 (S66).

Receiving this, the transaction processing part 41 may continuously transmit this moving picture file to the dedicated terminal 14 through the moving picture file processing part 42 (S67). In addition, in accordance with the same procedure as above, the settlement processing of the rental fee is carried out (S 68).

In the dedicated terminal 14, the data of the moving picture file that is transmitted by the data storing part 65 is stored in a predetermined area of the hard disk 22 (S 70). At the same time, this data is read by the reproduction processing part 66, and then, the moving picture and the voice are reproduced through the television set 29 (S71).

When the download is stopped because of down of the center server 12 and OFF of the power source of the dedicated terminal 14 or the like in the middle of download of the above-described moving picture file, the data storing part 65 may state the number of bytes that are received so far in the download database within the hard disk 22.

Then, when the network between the dedicated terminal 14 and the center server 12 is restored, the distribution requesting part 64 may check the number of received bytes that are stated in the above-described download database and may require distribution of remains of this moving picture file of the center server 12.

Receiving this, the transaction processing part 41 transmits the moving picture data to the dedicated terminal 14 by remaining number of bytes through the moving picture file processing part 42 by block units.

Due to this so-called byte range distribution function, this second video rental system 60 does not have to download the moving picture file with comparatively high volume again from the first, so that it is possible to realize the efficient distribution of the moving picture file. In the meantime, this byte range distribution function is also applicable when the moving picture file is distributed from the center server 12 to the dedicated terminal 14 in the above-described shopping system or the first video rental system.

The user can view the moving picture file stored in the hard disk 22 many times till the expiration date comes.

Specifically, when the user inserts his or her own ID card 50 into the IC card reader 26 of the dedicated terminal 14, the list generating part 68 may check the download database in the hard disk 22, may extract the video title with related to the ID of this user, and may generate a list.

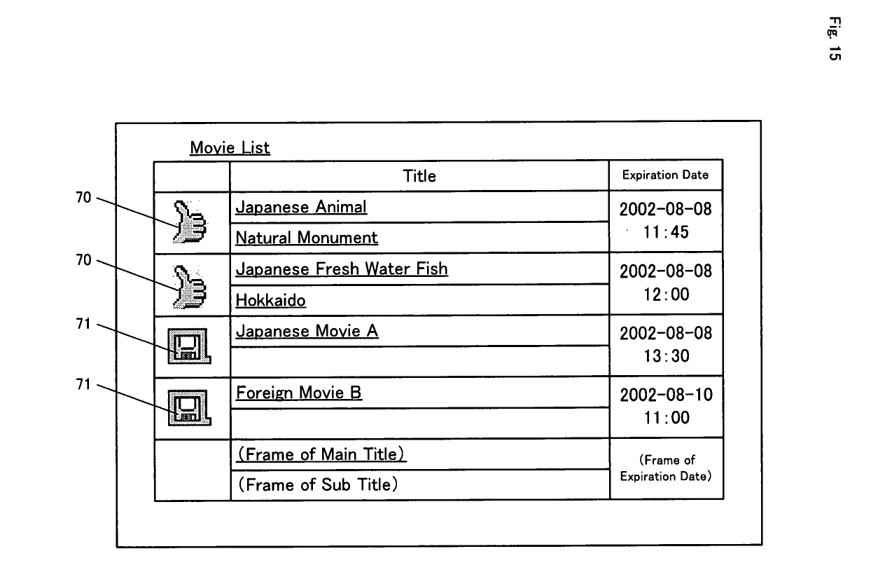

FIG. 15 shows an example of this list, and in the list, titles (a main title/a sub title) and an expiration date are listed.

In addition, an icon indicating the present condition is attached to each video title. For example, a “OK mark 70” with a thumb pointed upward is added to “Japanese animal/natural monument”, and this indicates that the download of this video title has been completed and the corresponding moving picture file has been stored in the hard disk 22.

On the contrary, a “FD mark 71” copying a flexible disk is attached to a “Japanese movie A”, and it indicates that the user subscribes the video rental and the settlement has been complete, however, the download thereof is not completed because of some cause and the download is reserved.

In this case, if the user selects the video title to which the FD mark 71 is attached by the remote control operation, the distribution requesting part 64 outputs the download request of the corresponding moving picture file to the center server 12 and this moving picture file is transmitted from the moving picture file processing part 42.

The data of the transmitted moving picture file is read by the reproduction processing part 66 at the same time as the data are stored sequentially in the hard disk 22 by the data storing part 65, and the data is reproduced though the screen and the speaker of the television set 29.

In the meantime, in the case that the data of a part of the moving picture file is stored in the hard disk 22, due to the byte range distribution function as same as the above, the distribution requesting part 64 requires the subsequent transmission of the data of the center server 12, and the data by remaining number of bytes are transmitted from the moving picture file processing part 42 by block units.

The capacity of the hard disk 22 of the dedicated terminal 14 has a predetermined limit (for example, 20 to 100 GB), so that if many moving picture files are downloaded, this results in running out of the disk capacity.

Therefore, if the disk capacity runs short during storing of the moving picture data by the data storing part 65 (S69), the file managing part 67 carries out deletion processing of the stored moving picture files (S72) and a necessary area is secured.

In this case, the file managing part 67 may check the expiration date information of the stored moving picture files and may delete the files from one near to the expiration date.

However, also with respect to the deleted moving picture file, as long as the effective period remains, the title of the moving picture file is displayed with the FD mark 71 attached in the list that is formed by the list generating part 68.

Therefore, if the user who wants to view this moving picture file selects the title by the remote controller, the distribution requesting part 64 transmits a request of re-download to the center server 12 and this enables immediately distribution and the synchronous reproduction.

In this case, according to need, the deletion processing of other stored moving picture file is carried out by the file managing part 67 so as to secure the capacity of the disk.

The list generating part 68 may check the expiration date information of each moving picture file upon generating a list, and the moving picture file after the expiration date is deleted from the list. As a result, the user cannot reproduce the moving picture file hereinafter.

However, as long as the hard disk 22 has the sufficient capacity, the moving picture file after the expiration date is not deleted immediately but it is held in the hard disk 22 for a predetermined time (for example, five hours).

When request for the rental again with respect to the same title is inputted within this period of time, the distribution requesting part 64 transmits this request to the center server 12 and accounting processing is carried out by the transaction processing part 41, however, distribution of the moving picture file is not carried out.

Instead, new expiration date information is added to the moving picture file that is held in the hard disk 22 of the dedicated terminal 14, and the list generating part 68 adds the information to the movie list shown in FIG. 15. In this case, as a matter of course, the “OK mark 70” is attached to the video title.

On the contrary, after five hours passed from the expiration date, the moving picture file is deleted by the file managing part 67.

As a result, in the case of renting the video again, this moving picture file is distributed again.

In the meantime, if the expiration date comes and the hard disk 22 runs out of its capacity when the moving picture file is left therein temporarily, as a matter of course, the file managing part 67 deletes this moving picture file first.

The list generating part 68 only makes the moving picture file to be listed, which is related to the user ID that is recorded in the ID card 50, to be displayed on the screen of the television set 29.

Accordingly, even if some family members share one dedicated terminal 14 and many moving picture files that are individually downloaded by each person are stored in the hard disk 22, only the moving picture file with related to the user who is inserting the ID card 50 at the present time is selected to be displayed on the list.

Therefore, even if the moving picture file to which a classification code of adults is attached is stored in the hard disk 22, when the child user uses this moving picture file, this is not displayed on the list, so that this moving picture file cannot be reproduced.

In the meantime, in the case of downloading the moving picture file of about two hours from the center server 12, if an ADSL circuit of a comparatively low speed is used, it takes about two hours.

As a matter of course, in the case of this system 60, the reproduction is carried out at the same time as download, and a so-called trick play such as rewind and fast-forwarding becomes also possible by block units, so that the user does not have to wait for two hours.

However, in order to enjoy the trick play freely with respect to the entire moving picture file, it is necessary that the entire moving picture file has been downloaded.

Therefore, the user can set reservation of download without reproduction on the dedicated terminal before going to bed or before going to work.

If the set time has come, the distribution requesting part 64 is activated to request distribution of the moving picture file recording of which is reserved by the user of the center server 12.

Then, the moving picture data transmitted from the moving picture file processing part 42 is stored in the hard disk 22 by the data storing part 65.

As a result, just after getting out of bed or coming home, the user can enjoy the trick play on the downloaded moving picture file.

Further, the user can reserve download of the moving picture file from a place where the user has gone through a cellular phone, a PDA (Personal Digital Assistant), and a notebook personal computer provided with the Internet connecting function.

The user accesses the Web site dedicated for the cellular phone that is located in the center server 12, for example, from a cellular phone 72 via the Internet 18 and inputs his or her own user ID and password, and then, the user may select “reservation of download” from the service menu.

Receiving this, the reservation processing part 61 transmits a retrieving page of the moving picture file capable of being reserved and this retrieve page is displayed on a display of the cellular phone 72.

On the contrary, the user specifies the key word and the genre or the like and selects the intended video title, and then, the user selects and inputs a date and time of starting the download and transmits it to the center server 12.

Receiving this, the reservation processing part 61 may pass the reservation information inputted by the user to the mail processing part 62 to generate an electronic mail for reservation of download.

With respect to this electronic mail, the ID and the mail server name (the mail address) of this user are stated in a column of a destination, and at the same time, characters indicating that this electronic mail is a reservation mail such as “DNA RESERVE” are stated in a column of a title.

Further, the following information is stated in a column of a main text.
(1) URL of a content server having a moving picture file stored therein+a name of a file+an extension
(2) A file name of a moving picture file
(3) An extension of a moving picture file (a file system)
(4) A title character when displaying in a list
(5) An expiration date of rental
(6) A classification of contents
(7) A time of starting download

The followings are specific examples of the reservation mail.

<Subject>

DNARESERVE

<A main text>

movie_url=http://enrak.tv/video/artol.m4t←(1)
movie_title=art01 ←(2)
movie_type=m4t←(3)
movie_list=Japanese movie A←(4)
expiration=2002-08-18 10:46:21←(5)
protected=1←(6)
dl_time=2002-08-15 15:25:00←(7)

The mail receiving part 63 of the dedicated terminal 14 may be connected to the mail processing part 62 (the mail server) of the center server 12 periodically (for example, intervals of ten minutes) on the basis of the user ID and the mail server information that are descried in the ID card 50 inserted at the present time to require distribution of the reservation mail.

In the case that the reservation mails are accumulated in a mail box of the user, the mail receiving part 63 may receive this electronic mail from the mail processing part 62 and may extract the reservation information stated in the column of the main text (after extracting the reservation information, the electronic mail is deleted).

This reservation information is passed to the distribution requesting part 64, and the distribution requesting part 64 may require distribution of this moving picture file of the center server 12.

Receiving this, the transaction processing part 41 distributes the intended moving picture file to the dedicated terminal 14 via the moving picture file processing part 42 after carrying out the necessary accounting processing.

This moving picture file is stored in the hard disk 22 via the data storing part 65.

As a result, the user may reproduce the intended moving picture file just after coming home and the user can enjoy the trick play.

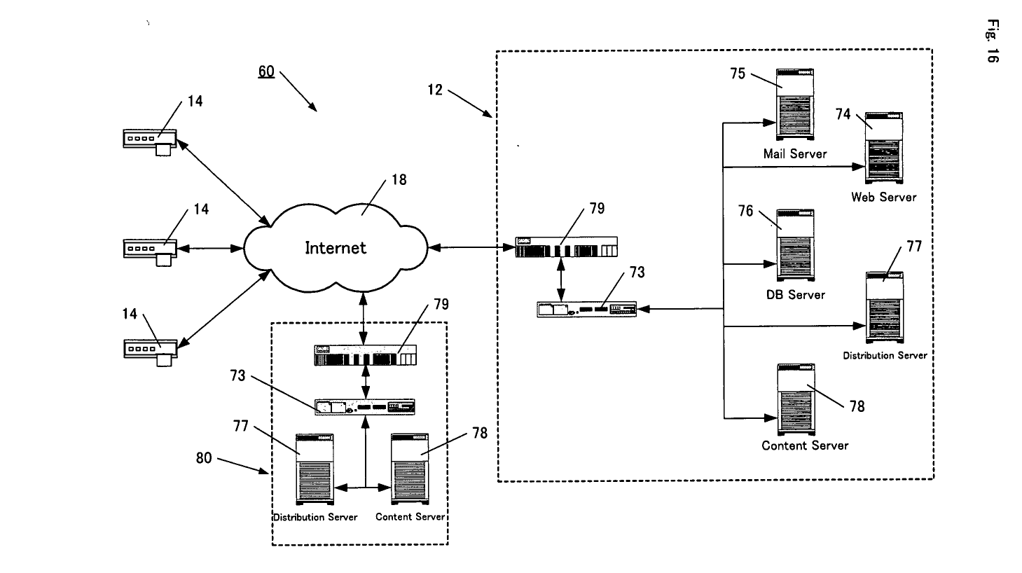

FIG. 16 shows an example of a server configuration of the second video rental system 60, and the center server 12 is provided with a Web server 74 connected via a hub 73, a mail server 75, a database server 76, a distribution server 77, and a content server 78. Each server is connected to the Internet 18 via a rooter 79.

In this case, the Web server 74 may function as the transaction processing part 41, the authentication processing part 43, the expiration date managing part 40, the Web page generating part 44, and the reservation processing part 61 or the like; and the mail server 75 may function as the mail processing part 62.

In addition, in the database server 76, the user database 47, the commodity and service database 45, and the moving picture database 46 are provided.

Further, the distribution server 77 functions as the moving picture file processing part 42 and the real moving picture file is stored in the content server 78.

As shown in the drawing, it is also possible to disperse and arrange the distribution server 77 and the content server 78 in a place different from the center server 12.

As a result, for example, the distribution server 77 and the content server 78 are located in a movie company 80 having a copyright of the moving picture file and the necessary data with respect to the moving picture file is registered in the database server 76 within the center server 12. Then, when the distribution request is inputted from the user, it is possible to distribute the moving picture file to the dedicated terminal 14 through the distribution server 77 of this movie company 80.

The example that the moving picture file is transmitted from the side of the center server 12 to the dedicated terminal 14 is described above. However, this system 10 can carry out interactive distribution of the moving picture file, so that it is also possible for the system 10 to transmit the moving picture file that is photographed by the user to the center server 12 or to distribute this to other user and the local server 16 of the commodity and service provider by relay of the center server 12.

In this case, the user may connect the head set 33 for inputting and outputting the voice to the CCD camera 32 for inputting an image to the dedicated terminal 14.

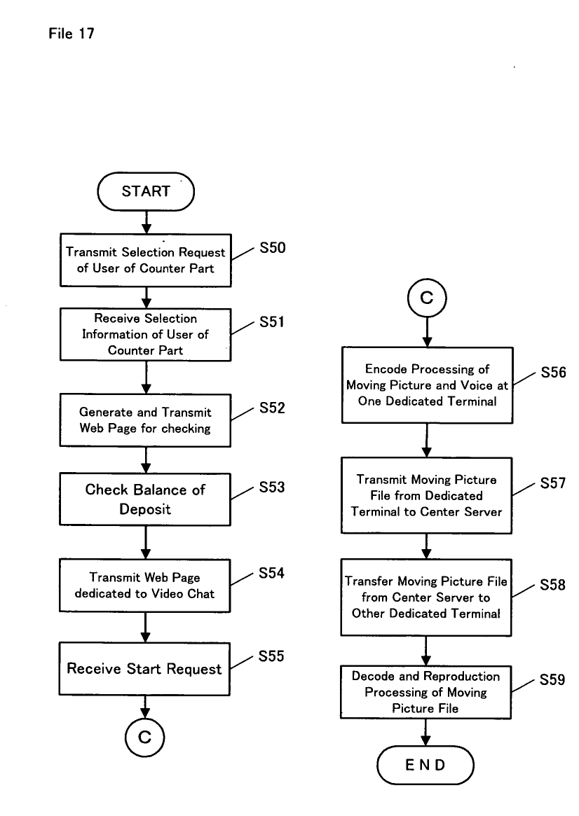

Hereinafter, in accordance with the flow chart shown in FIG. 17, a processing procedure when the user uses this system 10 as a video chat system (an interactive system) will be explained below.

At first, the user who wants to do video chat (a TV conference) with other user by using a interactive moving picture file distribution function of this system 10 selects the “video chat” button 54 from the opening menu shown in FIG. 7.

As a result, from the Web page generating part 44, the Web page requiring the selection of the user ID of a counter part is transmitted (S50). On the contrary, the user selects a numeric keyboard on the screen 53 by operating the remote controller 52 to select and input the user ID of the counter part.

From the Web page generating part 44 receiving this (S51), a check screen displaying the name of the counter part and the service fee or the like is transmitted (S52).

On the contrary, when the user selects the “check” button on the screen 53, the transaction processing part 41 checks the balance information in the user database 47 (S53), and if the balance is enough, the transaction processing part 41 describes the order information in the record in the commodity and service database 45 and at the same time, it updates the balance obtained by subtracting the service fee from the balance and registers it in the user database 47 as a new balance.

Simultaneously, the Web page for carrying out the video chat is distributed to the dedicated terminals 14 of the user who subscribes the system and the counter user from the Web page generating part 44 (S54).

In this case, if the both users select the “start” button on the screen 53 (S55), hereinafter, the video chat between the users relayed through the center server 12 becomes possible.

In other words, the image and the voice of one user is inputted in the dedicated terminal 14 via the CCD camera 32 and the microphone of the head set 33, and then, it is converted into the MPEG 4 system by the media processor 27 (S56) and it is divided into the JP packets to be transmitted to the center server 12 via the Internet 18 (S57).

The moving picture file processing part 42 of the center server 12 may transfer this IP packet to the dedicated terminal 14 of the counter user (S58).

In the dedicated terminal 14 of the counter user, the decoding processing is applied to the moving picture data, and the image data is displayed on the television screen 53 and at the same time, the voice data is outputted from the headphone (S59).

In the both dedicated terminals 14, the above-described encoding/decoding processing is carried out in real time and this makes the interactive distribution and reproduction of the moving picture file be realized.

In the meantime, depending on the user's selection, the moving picture files according to the video chat are accumulated in the hard disk 22 of the both dedicated terminals 14.

In addition, it is also possible to leave backup of this moving picture data at the side of the center server 12. In the case that this backup request is transmitted from the dedicated terminal 14 of the user to the center server 12, the moving picture file processing part 42 may store the moving picture file transmitted from the dedicated terminals 14 of the both users in the hard disk of the server and may describe the necessary items in the moving picture database 46.

This video chat has a sufficient utility value as a communication tool between the individuals such as between husband-alone transfer and his wife, however, it has a higher utility value as the communication tool between the general user and the provider.

For example, if the system is configured in such a manner that, when the user who is doing the online shopping selects the button of “interactive explanation” displayed in the vicinity of the moving picture advertisement display area of the commodity, the user can directly talk to the staff of the commodity provider, the user can make an inquiry about a point that is not clear by the one-way explanation of the commodity till the user is satisfied.

The system can be applied to a remote-type English conversation lesson, a remote-type PC support, a remote-type caring business, and a remote-type consultation by a doctor or the like.

The example that this system 10 is built by connecting the dedicated terminal 14 of a stationary type to the television set 29 of a stationary type, however, for example, the system can be also built by a compact PDA having the OS such as Linux incorporated therein.

In this case, the dedicated program necessary for realizing the function as the dedicated terminal is stored in the memory of the PDA. In addition, a liquid crystal display and a speaker of the PDA take place of the television set 29.

This PDA is connected to the center server 12 via the Internet 18 by inserting a wireless communication card into a CF card slot. Alternatively, the user can access to the center server 12 by cooperation between a Bluetooth module embedded in the main body and a cellular phone corresponding to Bluetooth.

As same as the static dedicated terminal 14, the authentication of the user is completed by inserting the his or her own ID card into the card slot of the PDA, and the user can select a menu by tapping the liquid crystal display with a stylus pen.

The moving picture data of the MPEG 4 format that is transmitted form the center server 12 is decoded by the dedicated program in the PDA to be streaming-reproduced through the liquid crystal display and the speaker. This moving picture data is stored in the incorporated portable hard disk at the same time as the reproduction.

In the case of carrying out the video chat, the image and the voice of the user are taken in by using the incorporated or outside CCD camera and microphone.

### Industrial Applicability

According to the shopping system using the moving picture distribution technique of the invention, the authentication of the user is completed only by inserting his or her ID card into the dedicated terminal that is continuously connected with the Internet, so that the user can casually view the moving picture advertisement through the television screen. In addition, by using the remote controller as the “input means”, even the user who is not familiar with the PC can enjoy the online shopping through the Internet without a sense of discomfort.

Since the moving picture file for advertisements is distributed upon receiving of the selection request of the user, the user can view the moving picture advertisement of the commodity and the service attracting the user's interest at any time.

Further, since the system is configured in such a manner that the Web page for selecting the service is transmitted from the center server and the user selects specific commodity and service from this Web page, there is no need for the user to access to many Web sites. As a result, even if the user lacks of the knowledge about the Internet, he or she can enjoy the online shopping definitely and there is no risk that he or she is deceived by a dishonest trader.

According to the video rental system using the moving picture distribution technique according to the present invention, the user can receive the rental video service casually as same as the above-described online shopping system.

Further, differently from the conventional rental video, the system is configured in such a manner that the moving picture file of the main body of the video is distributed via the Internet to be displayed on the television display, so that this has an advantage that there is no need for the user to go to a rental video shop. Also for a rental video provider, there is an advantage that there is no need to prepare a shop and staffs.

The user can reproduce the moving picture file stored in the hard disk of the dedicated terminal many times till the expiration date comes, and the copy right can be securely protected because the moving picture file is deleted within a predetermined hour beyond the expiration date.

According to the interactive system using the moving picture distribution technique of the present invention, the user can enjoy the online video chat casually.

1. A shopping system using a moving picture distribution technique comprising a center server, a dedicated terminal connected to the center server via the Internet, and an ID card belonging to each user; characterized in that:
the center server comprising:
a user database for storing the attribution information of each user therein as being related to a user ID and a dedicated terminal ID;
a commodity and service database for storing the information with related to a commodity and a service that can be provided to a user;
a storage apparatus for accumulating a moving picture file for advertisements of the commodity and the service;
a moving picture database for storing the information with related to each moving picture file for advertisements therein;
means of carrying out authentication processing with reference to the user database when the dedicated terminal transmits the user ID and the dedicated terminal ID;
means of generating a Web page for selecting a commodity and a service with reference to the commodity and service database and transmitting it to the dedicated terminal;
means of extracting the moving picture file for advertisements with related to the commodity and the service with reference to the moving picture database when the dedicated terminal transmits the information for selecting specific commodity and service, and of transmitting this moving picture file for advertisements to the dedicated terminal; and
means of transmitting the order information of the commodity and the service to a communication terminal of a commodity and service provider when a purchase request of a commodity and a service according to a moving picture file for advertisements is transmitted from the dedicated terminal; and
wherein the dedicated terminal comprising:
input and output terminals for connecting the dedicated terminal to a television set;
a card reader for reading the user ID and the dedicated terminal ID stored in the ID card;
means of transmitting the user ID and the dedicated terminal ID to the center server and of requiring authentication of the user;
means of displaying the Web page for selecting the commodity and the service transmitted from the center server on a TV screen;
inputting means for selecting the commodity and the service displayed on the TV screen;
means of transmitting the commodity and service information selected by the user to the center server and requiring the distribution of the moving picture file for advertisements;
means of displaying an image of the moving picture file for advertisements transmitted from the center server on the television screen and outputting a voice through a speaker; and
means of transmitting a purchase request of the commodity and the service to the center server when the user selects purchase of the commodity and the service through the input means.

2. The shopping system using the moving picture distribution technique according to claim 1, characterized in that:
the dedicated terminal incorporates a hard disk therein and comprises means of storing the moving picture file for advertisements in the hard disk at the same time as reproduction of the moving picture file for advertisements.

3. The shopping system using the moving picture distribution technique according to claim 2, characterized in that:
the moving picture file for advertisements is related to the expiration date information in advance;
wherein the dedicated terminal comprises means of deleting the moving picture file when the expiration date of the moving picture file stored in the hard disk comes; and
wherein the center server comprises means of checking if the moving picture file is deleted or not with reference to the interior of the hard disk of the dedicated terminal after the expiration date of the moving picture file; and
means of transmitting an instruction to delete the moving picture file to the dedicated terminal when the moving picture file remains.

4. The shopping system using the moving picture distribution technique according to claim 2 or 3, characterized in that:
the dedicated terminal comprises means of embedding at least one of the user ID and the dedicated terminal ID in each frame composing a moving picture as the electronic watermark information when reproducing the moving picture file that is transmitted from the server.

5. The shopping system using the moving picture distribution technique according to any one of claims 1 to 4, characterized in that:
the center server comprises means of coding the moving picture file for advertisements and means of transmitting this coded moving picture file for advertisements to the dedicated terminal.

6. The shopping system using the moving picture distribution technique according to any one of claims 1 to 5, characterized in that:
the center server comprises a database for setting an allowable limit of trading of the user and means of rejecting the trading when the purchase request of the commodity and the service over the allowable limit of trading of the user is transmitted from the dedicated terminal.

7. The shopping system using the moving picture distribution technique according to any one of claims 1 to 6, characterized in that:
the center server comprises a database for setting a trade forbidden condition of the user and means of rejecting the trading when the purchase request of the commodity and the service complying with the trade forbidden condition is transmitted from the dedicated terminal.

8. The shopping system using the moving picture distribution technique according to any one of claims 1 to 7, characterized in that:
the center server comprises a database for accumulating a purchasing history information of the commodity and the service by the user and means of generating a Web page for displaying by priority the commodity and the service belonging to the same genre as the commodity and the service that were purchased by the user with reference to the history information when generating the Web page for selecting the commodity and the service.

9. The shopping system using the moving picture distribution technique according to any one of claims 1 to 7, characterized in that:
the center server comprises a database for accumulating a distribution history information to the moving picture file for advertisements of the user and means of generating a Web page for displaying by priority the commodity and the service belonging to the same genre as the commodity and the service according to the moving picture file for advertisements that was distributed to the user with reference to the history information when generating the Web page for selecting the commodity and the service.

10. The shopping system using the moving picture distribution technique according to any one of claims 1 to 9, characterized in that:
the center server comprising:
a database for recording a balance of a deposit of the user;
means of comparing the price information of the commodity and the service with the balance when the purchase request of the commodity and the service is transmitted from the dedicated terminal and determining availability of settlement;
means of transmitting the order information of the commodity and the service to the communication terminal of the commodity and service provider when the settlement is available; and
means of subtracting a settlement amount from the balance of the user.

11. The shopping system using the moving picture distribution technique according to any one of claims 1 to 10, characterized in that:
the ID card stores the card information for realizing a credit card function or a debit card function therein;
wherein the dedicated terminal comprises a card reader for reading the card information and means of transmitting the card information to the center server; and
wherein the center server comprising:
means of transmitting the price information of the commodity and the service and the card information to a host computer of a credit card company or a banking institution when the purchase request of the commodity and the service is transmitted from the dedicated terminal to make a reference about availability of settlement, and
means of transmitting the order information of the commodity and the service to the communication terminal of the commodity and service provider when the settlement is available.

12. The shopping system using the moving picture distribution technique according to any one of claims 2 to 11, characterized in that:
the center server comprises means of extracting regularly or irregularly the optimum moving picture file for advertisements for each user and transmitting it to the dedicated terminal as being related to the user ID; and
wherein the dedicated terminal comprising:
means of storing the moving picture file for advertisements transmitted from the center server in the hard disk; and
means of reading the moving picture file for advertisements related to the user from the hard disk in a spare time when the user is receiving other moving picture file from the center server and of reproducing it through the television set.

13. The shopping system using the moving picture distribution technique according to claim 12, characterized in that:
the center server comprises a database for accumulating a purchase history information of the commodity and the service by the user and means of extracting by priority a moving picture file for advertisements with related to the commodity and the service belonging to the same genre as the commodity and the service that were purchased by the user with reference to the history information when transmitting the moving picture file for advertisements to the dedicated terminal of each user.

14. The shopping system using the moving picture distribution technique according to claim 12, characterized in that:
the center server comprises a database for accumulating a distribution history information of the moving picture file for advertisements to the user and means of extracting by priority a moving picture file for advertisements with related to the commodity and the service belonging to the same genre as the commodity and the service that were distributed to the user with reference to the history information when transmitting the moving picture file for advertisements to the dedicated terminal of each user.

15. The shopping system using the moving picture distribution technique according to any one of claims 1 to 14, characterized in that:
the dedicated terminal comprises means of transmitting the reproduction achievement information to the center server when it reproduces the moving picture file for advertisements; and
wherein the center server comprising:
means of storing the reproduction achievement information in a predetermined database as being related to the user; and
means of transmitting this reproduction achievement information and the attribution information of the user to the communication terminal of the provider of the moving picture file for advertisements.

16. A video rental system using a moving picture distribution technique comprising a center server, a dedicated terminal connected to the center server via the Internet, and an ID card carried by each user; characterized in that:
the center server comprising:
a user database for storing the attribution information of each user therein as being related to a user ID and a dedicated terminal ID;
a rental video database for storing the information with related to a video that can be rented to a user;
a storage apparatus for accumulating a moving picture file of the rental video;
means of carrying out authentication processing with reference to the user database when the dedicated terminal transmits the authentication information of the user;
means of generating a Web page for selecting a video title with reference to the database and transmitting it to the dedicated terminal;
means of transmitting the moving picture file related to the video title and the expiration date information of the moving picture file to the dedicated terminal when the information selecting a specific video title is transmitted from the dedicated terminal;
wherein the dedicated terminal incorporates a hard disk and a card reader therein and is connected to a television set; and
wherein the dedicated terminal comprising:
means of transmitting the authentication information read by the card reader to the center server and of requiring authentication of the user;
means of displaying the Web page for selecting the video title that is transmitted from the center server on a TV screen;
input means for selecting the video title displayed on the TV screen;
means of transmitting the video title selected by the user to the center server and requiring the distribution of the corresponding moving picture file;
means of storing the moving picture file transmitted from the center server in the hard disk;
means of displaying an image of the moving picture file on the television screen and outputting a voice through a speaker; and
means of deleting the moving picture file within a predetermined time of period when the expiration date of the moving picture file stored in the hard disk comes.

17. The video rental system using a moving picture distribution technique according to claim 16, characterized in that:
the center server comprising:
means of checking if the moving picture file is deleted or not with reference to the interior of the hard disk of the dedicated terminal after the expiration date of the moving picture file; and
means of transmitting an instruction to delete the moving picture file to the dedicated terminal when the moving picture file remains.

18. The video rental system using a moving picture distribution technique according to claim 16 or 17, characterized in that:
the center server comprises means of transmitting the moving picture file to the dedicated terminal by plural blocks; and
wherein the dedicated terminal comprising:
means of storing the moving picture file transmitted from the center server in the hard disk by block units; and
means of carrying out fast-forwarding reproduction, rewind reproduction, pause, and play back at low speed of the moving picture data included in the transmitted block.

19. The video rental system using a moving picture distribution technique according to any one of claims 16 to 18, characterized in that:
the dedicated terminal comprising:
means of making a reference about total number of bytes of the moving picture file to the center server prior to the moving picture distribution request;
means of recording the total number of the byte notified from the center server in the predetermined database;
means of recording the number of the received bytes in the database when download of the moving picture file is stopped in the middle of download;
means of notifying the center server of the number of the received bytes when download of the moving picture file is started again; and
means of storing the continuous data of the moving picture file in the hard disk when it is transmitted from the center server; and
wherein the center server comprises means of transmitting the remaining data of the moving picture file to the dedicated terminal when the number of the received bytes is notified in response to the distribution request of a specific moving picture file from the dedicated terminal.

20. The video rental system using a moving picture distribution technique according to claim 19, characterized in that:
the dedicated terminal comprises means of securing a necessary capacity by deleting the moving picture file from one near to the expiration date with reference to the expiration date of each moving picture file stored in the hard disk when determining that the hard disk runs out of its capacity upon download of a new moving picture file.

21. The video rental system using a moving picture distribution technique according to any one of claims 16 to 20, characterized in that:
the dedicated terminal comprising:
a database for recording the information with related to a downloaded moving picture file, a moving picture file download of which is reserved, and a moving picture file deleted as its expiration date remains as being related to the user ID;
means of generating a list on which a title and an expiration date of the moving picture file according to the user are stated with reference to the user ID and the database that are read from the card reader; and
means of displaying the list on the TV screen.

22. The video rental system using a moving picture distribution technique according to claim 21, characterized in that:
a mark indicating that the download is not completed is attached to the moving picture file download of which is reserved and the moving picture file deleted as its expiration date remains that are stated in the list, and a mark indication that the download is completed is attached to the downloaded moving picture file; and
the dedicated terminal comprises means of requesting distribution of the moving picture file according to the title of the center server when the user selects the title of the video download of which is not completed on the TV screen.

23. The video rental system using a moving picture distribution technique according to claim 21 or 22, characterized in that:
the dedicated terminal comprising:
means of recording a flag of undisplay with respect to the moving picture file in the database when the expiration date of the moving picture file comes;
means of transmitting request to rent the moving picture file again to the center server when the user inputs a request of rental of the moving picture file again within a predetermined time of period;
means of recording the expiration date in the database as being related to the moving picture file when the center server notifies a new expiration date; and
means of displaying the moving picture file in the list to be downloaded; and
wherein the center server comprises means of notifying the moving picture file of a new expiration date when a request of rental of a specific moving picture file again is transmitted from the dedicated terminal within a predetermined time of period after the expiration date.

24. The video rental system using a moving picture distribution technique according to any one of claims 16 to 23, characterized in that:
the center server comprising:
means of, when a request of reservation of download is transmitted from a communication terminal operated by the user via the Internet, transmitting a Web page requiring input of the user ID and a password to the communication terminal,
means of transmitting a Web page for selecting a video title to the communication terminal when the user ID and the password are transmitted from the communication terminal of the user;
means of generating an electronic mail in which the download reservation information of the video title is stated when the information for selecting a specific video title from the communication terminal is transmitted, and accumulating it in a mail box of the user; and
means of transmitting the moving picture file to the dedicated terminal when the request of distribution of a specific video title is transmitted from the dedicated terminal; and
wherein the dedicated terminal comprising:
means of regularly connecting to the center server and requesting the distribution of the electronic mail with related to the user;
means of requesting the distribution of the moving picture file of the center server on the basis of the reservation information stated in this electronic mail when receiving the electronic mail from the center server; and
means of storing the moving picture file in the hard disk when the moving picture file is distributed from the center server.

25. The video rental system using a moving picture distribution technique according to any one of claims 16 to 24, characterized in that:
the dedicated terminal comprises means of embedding at least one of the user ID and the dedicated terminal ID in each frame composing a moving picture as the electronic watermark information when reproducing the moving picture file that is transmitted from the server.

26. The video rental system using the moving picture distribution technique according to any one of claims 16 to 25, characterized in that:
the center server comprises means of coding the moving picture file and means of transmitting this coded moving picture file to the dedicated terminal.

27. The video rental system using the moving picture distribution technique according to any one of claims 16 to 26, characterized in that:
the center server comprises a database for setting an allowable limit of trading of the user and means of rejecting the trading when the request to rent the video over the allowable limit of trading of the user is transmitted from the dedicated terminal.

28. The video rental system using the moving picture distribution technique according to any one of claims 16 to 27, characterized in that:
the center server comprises a database for setting a trade forbidden condition of the user and means of rejecting the trading when the request to rent the video complying with the trade forbidden condition is transmitted from the dedicated terminal.

29. The video rental system using the moving picture distribution technique according to any one of claims 16 to 28, characterized in that:
the center server comprises a database for accumulating a rental history information of the user and means of generating a Web page for displaying by priority the video title included in the genre that was rented by the user with reference to the history information when generating the Web page for selecting the rental video.

30. The video rental system using the moving picture distribution technique according to any one of claims 16 to 29, characterized in that:
the center server comprising:
a database for recording a balance of a deposit of the user;
means of comparing the rental fee information with the balance when the request to rent the video is transmitted from the dedicated terminal and determining availability of settlement;
means of transmitting the moving picture file to the dedicated terminal when the settlement is available; and
means of subtracting a settlement amount from the balance of the user.

31. The video rental system using the moving picture distribution technique according to any one of claims 16 to 30, characterized in that:
the ID card stores the card information for realizing a credit card function or a debit card function therein;
wherein the dedicated terminal comprises a card reader for reading the card information and means of transmitting the card information to the center server; and
wherein the center server comprising:
means of transmitting the rental fee information and the card information to a host computer of a credit card company or a banking institution when the request to rent the video is transmitted from the dedicated terminal to make a reference about availability of settlement, and
means of transmitting the moving picture file to the dedicated terminal when the settlement is available.

32. The video rental system using the moving picture distribution technique according to any one of claims 16 to 31, characterized in that:
the center server comprising:
a storage apparatus for accumulating a moving picture file for advertisements of a commodity and a service,
a database for storing the information with related to each moving picture file for advertisements, and
means of extracting regularly or irregularly the optimum moving picture file for advertisements for each user and transmitting it to the dedicated terminal as being related to the user ID; and
wherein the dedicated terminal comprising:
means of storing the moving picture file for advertisements transmitted from the center server in the hard disk; and
means of reading the moving picture file for advertisements related to the user from the hard disk in a spare time when the user is receiving the moving picture file of the rental video from the center server and of reproducing it through the television set.

33. The video rental system using the moving picture distribution technique according to claim 32, characterized in that:
the dedicated terminal comprises means of transmitting the reproduction achievement information to the center server when it reproduces the moving picture file for advertisements; and
wherein the center server comprising:
means of storing the reproduction achievement information in a predetermined database as being related to the user; and
means of transmitting this reproduction achievement information and the attribution information of the user to the communication terminal of the provider of the moving picture file for advertisements.

34. The video rental system using the moving picture distribution technique according to claim 32 or 33, characterized in that:
the dedicated terminal comprises means of transmitting a purchase request of the commodity and the service to the center server when the user selects the purchase of the commodity and the service according to the moving picture file for advertisements; and
wherein the center server comprising:
means of transmitting the order information of the commodity and the service to the communication terminal of the commodity and service provider when the purchase request is transmitted from the dedicated terminal;
the database for accumulating the purchase history of the commodity and the service by the user; and
means of extracting by priority the moving picture file for advertisements with related to the commodity and the service belonging to the same genre as the commodity and the service that were purchased by the user with reference to the purchase history information when transmitting the moving picture file for advertisement to the dedicated terminal of each user.

35. An interactive system using a moving picture distribution technique comprising a center server, a plurality of dedicated terminals connected to the center server via the Internet, and an ID card carried by the user; characterized in that:
the center server comprising:
a user database for storing the attribution information of each user therein as being related to a user ID and a dedicated terminal ID;
means of carrying out authentication processing with reference to the user database when each dedicated terminal transmits the user ID and the dedicated terminal ID;
means of generating a Web page to prompt to specify a user of a counter part and transmitting it to at least one dedicated terminal;
means of transmitting the moving picture file transmitted from the dedicated terminal to other dedicated terminal when one dedicated terminal transmits the information to specify the counter part; and
means of transmitting the moving picture file transmitted from other dedicated terminal to one dedicated terminal; and
wherein each dedicated terminal comprising:
input and output terminals for connecting the dedicated terminal to the television set;
input and output terminals for connecting the dedicated terminal to a camera for inputting an image and a microphone for inputting a voice;
a card reader for reading the user ID and the dedicated terminal ID that are stored in the ID card;
means of transmitting the user ID and the dedicated terminal ID to the center server and requesting the authentication of the user;
means of converting the image and voice of the user input through the camera or microphone into the moving picture file for transmission to the center server; and
means of displaying the image of the moving picture file from the dedicated terminal of the counter part transmitted from the center server on the TV screen and outputting the voice through the speaker.

36. The interactive system using a moving picture distribution technique according to claim 35, characterized in that:
the center server comprises storage means of storing the moving picture file transmitted from the both dedicated terminals.

37. The interactive system using a moving picture distribution technique according to claim 35 or 36, characterized in that:
each dedicated terminal incorporates a hard disk therein and comprises means of storing the moving picture file transmitted to the center server and the moving picture file transmitted from the center server in the hard disk.
